(19) United States
(12) Patent Application Publication
(10) Pub. No.: US 2026/0079242 A1
(43) Pub. Date: Mar. 19, 2026

(54) LIGHT-EMITTING UNIT HAVING HEAT DISSIPATION PROPERTIES AND TOF SENSOR INCLUDING THE SAME

(71) Applicant: OPTICIS CO., LTD., Seongnam-si (KR)

(72) Inventors: Hee Dae KIM, Gwangju (KR); Seong Geun KIM, Gwangju (KR)

(73) Assignee: OPTICIS CO., LTD., Seongnam-si (KR)

(21) Appl. No.: 19/025,377

(22) Filed: Jan. 16, 2025

(30) Foreign Application Priority Data
Sep. 13, 2024 (KR) 10-2024-0125395

(51) Int. Cl. G01S 7/481; G01S 17/08

(52) U.S. Cl. CPC G01S 7/4815; G01S 17/08

(57) ABSTRACT

Disclosed are a light-emitting unit having improved heat dissipation properties and a TOF sensor including the same. There is provided a light-emitting unit including a base substrate, light-emitting elements that are arranged on the base substrate as a plurality of groups and that are sequentially arranged on an outermost side of the base substrate and an inside thereof in a preset form, and address lines that are electrically connected to the groups of light-emitting elements, respectively, and that are electrically spaced apart from each other.

### CROSS-REFERENCE TO RELATED APPLICATION

The present application claims priority under 35 U.S.C. § 119(a) to Korean Patent Application No. 10-2024-0125395 filed in the Korean Intellectual Property Office on Sep. 13, 2024, the entire disclosure of which is incorporated herein by reference.

### BACKGROUND

### 1. Technical Field

The present embodiment relates to a light-emitting unit having heat dissipation properties and a time of flight (TOF) sensor including the same.

### 2. Related Art

Contents described in this part merely provide background information of the present embodiment, and do not constitute a conventional technology.

There emerge transport robots that are responsible for the transport of goods, such as goods or products having various sizes, in logistics warehouses and production lines. The transport robot may be driven in an autonomous driving mode in which the transport robot recognizes a current location according to an autonomous driving algorithm, generates an optimized path up to a target location, and tracks the optimized path. The transport robot may include a time of flight (TOF) sensor for recognizing a surrounding environment that surrounds the transport robot.

The TOF sensor may detect the time when light is emitted from multiple light-emitting elements and the time when reflected light reflected by a surrounding object is detected by the multiple light-receiving elements, and may detect a distance and location with respect to the surrounding object based on a light flight distance. The TOF sensor may include a light imaging detection and ranging (LIDAR) sensor, for example.

A conventional TOF sensor generates a large amount of heat due to light-emitting elements when operating for a predetermined time or more. However, the conventional TOF sensor has a structural difficulty in smoothly discharging the heat that is generated due to the light-emitting elements.

### SUMMARY

An embodiment of the present disclosure is directed to providing a light-emitting unit capable of turning on/off different groups of light-emitting elements at different times through a switch by using address lines that are electrically isolated, and a TOF sensor including the same.

An embodiment of the present disclosure is directed to providing a light-emitting unit, which is disposed in different groups of light-emitting elements so that lights capable of providing different spot sizes and visual field distances and having different forms are standardized and which includes different groups of optical lenses, and a TOF sensor including the same.

An embodiment of the present disclosure is directed to providing a light-emitting unit capable of reducing a heat dissipation problem that is caused as different groups of light-emitting elements are turned on at different times and light-emitting elements that are adjacent to each other are simultaneously turned on, and a TOF sensor including the same.

An embodiment of the present disclosure is directed to providing a light-emitting unit, which can maintain an appropriate amount of light from each light-emitting element by considering the number of light-emitting elements that are turned on according to time and can prevent the degradation of each light-emitting element in the state in which multiple light-emitting elements have been disposed on one base substrate, and a TOF sensor including the same.

An embodiment of the present disclosure is directed to providing a light-emitting unit including multiple light-emitting elements, wherein an ion implantation layer is formed in order to block the movement of a defect from a defect source, such as an oxide layer or an etching part, and to block the movement of a defect from the defect source to the central region of an active layer in which carrier confinement and optical confinement are performed, and a TOF sensor including the same.

Furthermore, an embodiment of the present disclosure is directed to providing a light-emitting unit having improved heat dissipation properties and a TOF sensor including the same.

According to an aspect of the present embodiment, there is provided a light-emitting unit including a base substrate, light-emitting elements that are arranged on the base substrate as a plurality of groups and that are sequentially arranged on the outermost side of the base substrate and the inside thereof in a preset form, and address lines that are electrically connected to the groups of light-emitting elements, respectively, and that are electrically spaced apart from each other.

According to an aspect of the present embodiment, the light-emitting unit further includes optical lenses arranged as a plurality of groups and disposed on each group of light-emitting elements.

According to an aspect of the present embodiment, the preset form is a rectangular form.

According to an aspect of the present embodiment, the preset form is a rectangular form in which one surface of the light-emitting element is opened.

According to an aspect of the present embodiment, a group of light-emitting elements that needs to radiate a light with relatively higher output is arranged on the outermost side.

According to an aspect of the present embodiment, the group of light-emitting elements is arranged inward therefrom in order of relatively weaker output.

According to an aspect of the present embodiment, the light-emitting unit further includes a switch for changing an alternative connection with a driving power supply between each group of address lines and the driving power supply.

According to an aspect of the present embodiment, there is provided a time of flight (TOF) sensor including a light-emitting element array including a light-emitting unit, a light-receiving unit configured to receive reflected light reflected by an object, and an operation processing unit configured to calculate a light flight time corresponding to a time difference between a light transmission time from the light-emitting unit and a light reception time when the light-receiving unit detects the reflected light, based on the light transmission time and the light reception time, and to calculate a distance up to the object based on the light flight time. The light-emitting unit includes a base substrate, light-emitting elements that are arranged on the base substrate as a plurality of groups and that are sequentially arranged on the outermost side of the base substrate and the inside thereof in a preset form, and address lines that are electrically connected to the groups of light-emitting elements, respectively, and that are electrically spaced apart from each other.

According to an aspect of the present embodiment, the preset form is a rectangular form or a rectangular form in which one surface of the light-emitting element is opened.

According to an aspect of the present embodiment, a group of light-emitting elements that needs to radiate a light with relatively higher output is arranged on the outermost side.

As described above, an aspect of the present embodiment has advantages in that different groups of light-emitting elements can be turned on/off at different times through the switch and different spot sizes and visual field distances can be provided by using the address lines that are electrically isolated.

An aspect of the present embodiment has an advantage in that a heat dissipation problem that is caused as different groups of light-emitting elements are turned on at different times and light-emitting elements that are adjacent to each other are simultaneously turned on can be reduced.

An aspect of the present embodiment has advantages in that an appropriate amount of light from each light-emitting element can be maintained by considering the number of light-emitting elements that are turned on according to time in the state in which multiple light-emitting elements have been disposed on one base substrate, the movement of a defect from a defect source, such as an oxide layer or an etching part, can be blocked in order to prevent the degradation of each light-emitting element, and the movement of a defect from a defect source to the central region of an active layer in which carrier confinement and optical confinement are performed can be blocked.

Furthermore, according to an aspect of the present embodiment, it is possible to improve heat dissipation properties.

### BRIEF DESCRIPTION OF THE DRAWINGS

FIG. 1 illustrates a diagram for describing a light-emitting element array EA in which multiple light-emitting elements are arranged in a two-dimensional way in an embodiment of the present disclosure.

FIG. 2 is a diagram that is taken along line II-II in FIG. 1 and that schematically illustrates the array of multiple light-emitting elements E that are arranged in a one-dimensional way in one direction.

FIG. 3 is a diagram that stereoscopically illustrates the light-emitting element E illustrated in FIG. 2.

FIG. 4 is a diagram illustrating a cross-sectional structure of the light-emitting element E according to an embodiment of the present disclosure.

FIGS. 5 to 7 are diagrams for describing the light-emitting element E illustrated in FIG. 4, and are diagrams illustrating cross-sectional structures of the light-emitting elements E in different phases in which the light-emitting elements E illustrated in FIG. 4 are formed.

FIG. 8 is a diagram illustrating a cross-sectional structure of the light-emitting element E according to another embodiment of the present disclosure.

FIGS. 9 to 11 are diagrams illustrating cross-sectional structures of the light-emitting elements E in different phases in which the light-emitting element E illustrated in FIG. 8 is formed.

FIG. 12 is a diagram that schematically illustrates a TOF sensor TOF, including a light-emitting unit EU including multiple light-emitting elements E and a light-receiving unit DU including multiple light-receiving elements.

FIG. 13 is a diagram illustrating a cross-sectional structure of the light-emitting unit EU including an optical lens array FA that is disposed in the light-emitting element array EA in an embodiment of the present disclosure.

FIG. 14 is a diagram illustrating forms of lights that are output from the light-emitting unit EU illustrated in FIG. 13 and that provide different spot sizes (or different radiation angles) and visual fields.

FIG. 15 is a diagram illustrating forms in which lights that provide different spot sizes (or different radiation angles) and visual fields are output according to time in a phase in which a first group of light-emitting element assemblies ES1 to a fourth group of light-emitting element assemblies ES4 are sequentially driven, for example, a phase in which the first group of light-emitting element assemblies ES1 to the fourth group of light-emitting element assemblies ES4 are driven at different times T1, T2, T3, and T4 in the light-emitting unit EU illustrated in FIG. 13.

FIG. 16 is a diagram contrastedly illustrating forms of lights that are output from first to fourth groups of light-emitting element assemblies ES1, ES2, ES3, and ES4, respectively, and that provide different spot sizes (or different radiation angles) and visual fields in the light-emitting unit EU illustrated in FIG. 13.

FIGS. 17A, 17B, and 17C illustrate a diagram for describing a construction that increases light intensity with the same spot size and a construction that reduces the spot size of light, as a construction for detecting an object at a long distance.

FIGS. 18A and 18B illustrate a diagram for describing a construction that increases sensitivity with the same light intensity.

FIGS. 19 to 24 illustrate diagrams for describing address structures of the light-emitting units EU having different address structures for independently applying driving power supplies V to the first to fourth groups of light-emitting element assemblies ES1, ES2, ES3, and ES4, respectively.

FIG. 25 illustrates a diagram for describing an embodiment in which a switching operation is implemented between first to four contact points CP1, CP2, CP3, and CP4 connected to first to fourth groups of address lines A1, A2, A3, and A4, respectively, and the driving power supply V.

FIG. 26 is a diagram illustrating a cross-sectional structure of a light-emitting unit EU including an optical lens array FA disposed in a light-emitting element array EA in another embodiment of the present disclosure.

FIG. 27 is a diagram illustrating forms of lights that are output from the light-emitting unit EU illustrated in FIG. 25 and that provide different spot sizes (or radiation angles) and visual fields.

FIG. 28 is a diagram illustrating different forms of lights that are output from the light-emitting unit EU illustrated in FIG. 26.

FIG. 29 is a diagram illustrating forms in which lights that provide different spot sizes (or different radiation angles) and visual fields are output according to time in a phase in which a first group of light-emitting element assemblies ES1 to a fourth group of light-emitting element assemblies ES4 are sequentially driven, for example, a phase in which the first group of light-emitting element assemblies ES1 to the fourth group of light-emitting element assemblies ES4 are driven at different times T1, T2, T3, and T4 in the light-emitting unit EU illustrated in FIG. 26.

FIG. 30 is a diagram illustrating a cross-sectional structure of the light-emitting unit EU including an overlap arrangement of a first condensing lens L1 supported on a light-emitting element E and a second condensing lens L2 spaced apart from the light-emitting element E in another embodiment of the present disclosure.

FIGS. 31 to 33 are diagrams illustrating lights that have different forms and that are provided from the light-emitting unit EU at different first to third locations g1, g2, and g3 of the second condensing lens L2 for the first condensing lens L1 in the light-emitting unit EU illustrated in FIG. 30.

FIGS. 34 to 37 are diagrams illustrating forms of lights that are biased at different degrees from the center of the first condensing lens L1 toward the center of the second condensing lens L2 through different curvature or refractive power or different optical arrangements of the first and second condensing lenses L1 and L2 in the light-emitting unit EU illustrated in FIG. 30.

FIGS. 38A to 38C illustrate diagrams for describing a technical effect that reduces the degradation of the light-emitting element E in the light-emitting element array EA or the light-emitting unit EU including the light-emitting element array EA according to an embodiment of the present disclosure.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part or a combination of them, and should be understood that it does not exclude the existence or possible addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

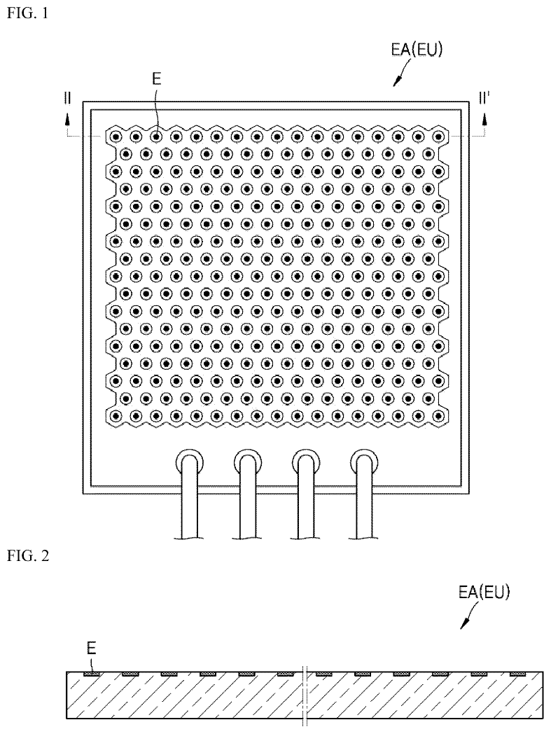

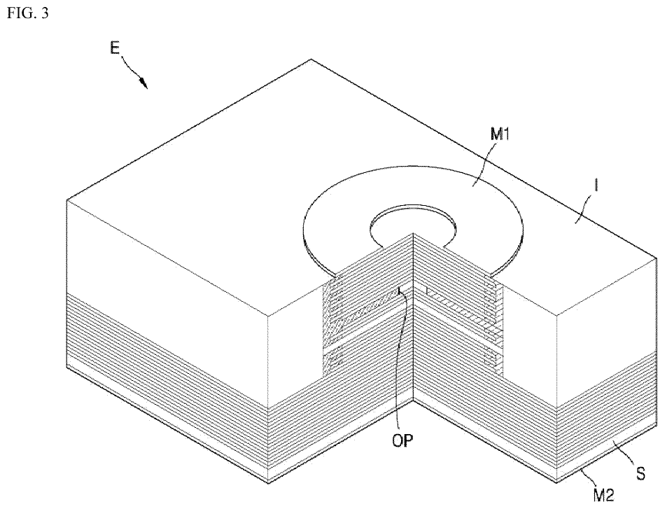

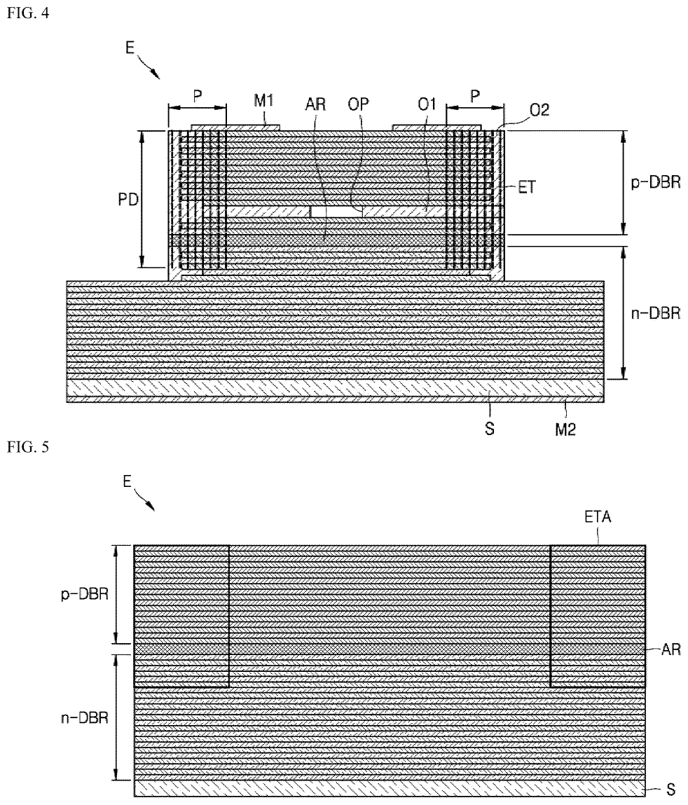

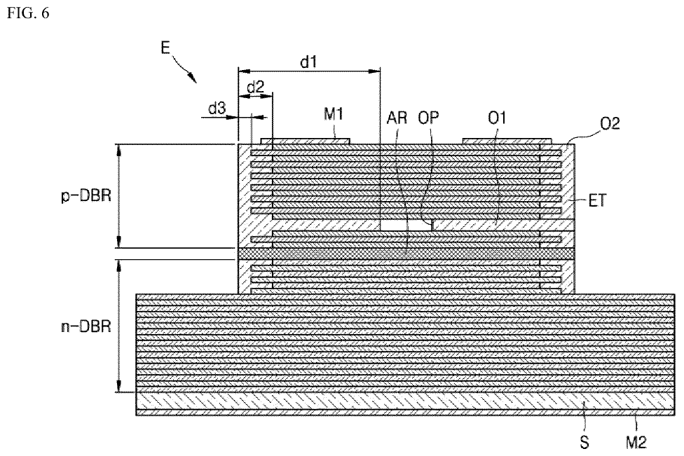

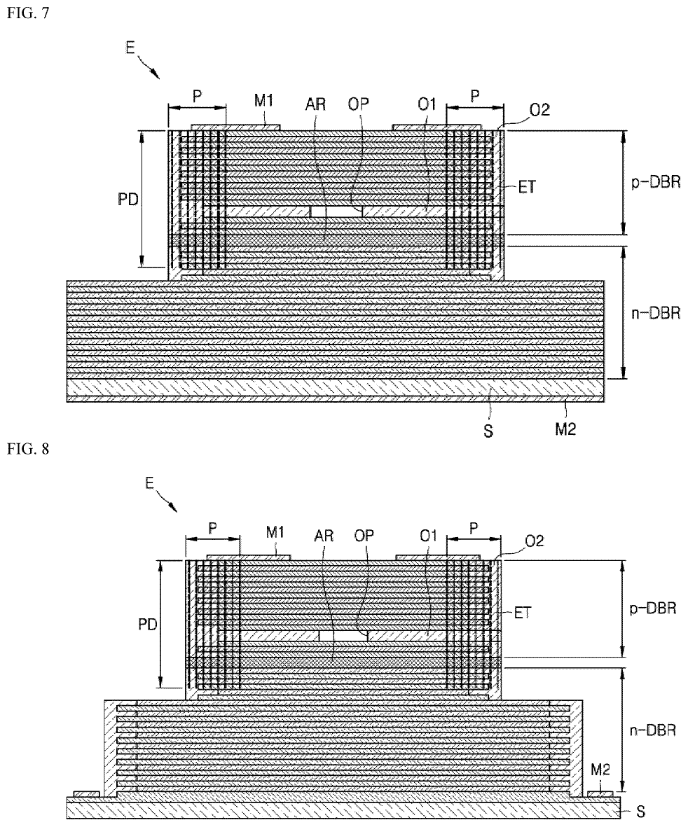

FIG. 1 illustrates a diagram for describing a light-emitting element array EA in which multiple light-emitting elements are arranged in a two-dimensional way in an embodiment of the present disclosure. FIG. 2 is a diagram that is taken along line II-II in FIG. 1 and that schematically illustrates the array of multiple light-emitting elements E that are arranged in a one-dimensional way in one direction. FIG. 3 is a diagram that stereoscopically illustrates the light-emitting element E illustrated in FIG. 2. FIG. 4 is a diagram illustrating a cross-sectional structure of the light-emitting element E according to an embodiment of the present disclosure. FIGS. 5 to 7 are diagrams for describing the light-emitting element E illustrated in FIG. 4, and are diagrams illustrating cross-sectional structures of the light-emitting elements E in different phases in which the light-emitting elements E illustrated in FIG. 4 are formed.

Referring to FIGS. 1 to 7, the light-emitting element E according to an embodiment of the present disclosure may include a vertical cavity surface emitting laser (VCSEL). The light-emitting element array EA according to an embodiment of the present disclosure may include a VCSEL array.

The light-emitting element array EA may include multiple light-emitting elements E arranged on one base substrate S in a two-dimensional way. For example, in an embodiment of the present disclosure, the light-emitting element E including the VCSEL may be relatively easy to standardize a form of light because the light-emitting element emits a Gaussian beam close to circular light compared to an edge emitting laser (EEL). As will be described later, the light-emitting element array EA according to an embodiment of the present disclosure may standardize light that is output from the light-emitting element E as light that provides a proper (having a preset size) spot size (e.g., radiation angle) and a proper (having a preset range) visual field because an optical lens F is disposed on the light-emitting element E.

The light-emitting element E is a laser device including an optically active semiconductor layer (e.g., an active layer AR) that is interposed between a pair of highly reflective mirror stacks (i.e., a P type distributed Bragg reflector (DBR) layer (p-DBR) and an N type DBR layer (n-DBR)). The highly reflective mirror stack (i.e., the P type DBR layer (p-DBR) or the N type DBR layer (n-DBR)) may include a metallic material, a dielectric material, or an epitaxailly-grown semiconductor layer. The optically active semiconductor layer (e.g., the active layer AR) may include AlInGaAs or InGaAsP. In an embodiment of the present disclosure, one of the pair of highly reflective mirror stacks (i.e., the P type DBR layer (p-DBR) and the N type DBR layer (n-DBR)) may be constructed to relatively less reflect light than the other of the pair of highly reflective mirror stacks so that coherent light that gathers at a resonant cavity that is formed between the pair of highly reflective mirror stacks (i.e., the P type DBR layer (p-DBR) and the N type DBR layer (n-DBR)) and that includes the active layer AR is discharged as laser light. In an embodiment of the present disclosure, the light-emitting element E may emit laser light with relatively less beam divergence from the top or bottom surface of the resonant cavity (including the active layer AR). The light-emitting element E may be arranged on the base substrate S in a one- or two-dimensional way. For example, the light-emitting element E may be formed in a different type of a gain-guided light-emitting element or an index-guided light-emitting element. For example, the index-guided light-emitting element is an oxide light-emitting element, and may include an oxide layer (a first oxide layer O1) for concentrating all of carriers and light and form an electrical resistance distribution and a refractive index distribution in a lateral direction thereof for carrier confinement and optical confinement by using the oxide layer (the first oxide layer O1) that surrounds an oxide opening OP. As described above, the carrier confinement and optical confinement in the lateral direction may increase the density of carriers and photons within the active layer AR. As a result, laser light can be efficiently generated within the active layer AR. In such an embodiment, a confinement region in which the carrier confinement and optical confinement are performed may be limited to the central region of the light-emitting element E in the lateral direction. The oxide opening OP may limit a current path along which carriers move. In various embodiments of the present disclosure, the oxide layer (the first oxide layer O1 may be formed as a part of a distributed Bragg reflector (DBR) that provides the pair of highly reflective mirror stacks (i.e., the P type DBR layer (p-DBR) and the N type DBR layer (n-DBR)).

In an embodiment of the present disclosure, each of the pair of highly reflective mirror stacks (i.e., the P type DBR layer (p-DBR) and the N type DBR layer (n-DBR)) may be formed to have a structure in which layers having different refractive indices have been alternately stacked, thus forming a DBR designed for a preferred operating laser wavelength, for example, a wavelength having a range of 650 nm to 1650 nm. For example, each of the pair of highly reflective mirror stacks (i.e., the P type DBR layer (p-DBR) and the N type DBR layer (n-DBR)) may be formed by alternately stacking layers consisting of AlGaAs containing a high ratio of aluminum and AlGaAs containing a low ratio of aluminum. For example, in an embodiment of the present disclosure, the pair of highly reflective mirror stacks (i.e., the P type DBR layer (p-DBR) and the N type DBR layer (n-DBR)) may have an effective optical thickness that is approximately ¼ of an operating laser wavelength. In this case, the effective optical thickness may correspond to a value that is obtained by multiplying the thickness of a corresponding layer by the refractive index of the corresponding layer. In various embodiments of the present disclosure, the pair of highly reflective mirror stacks (i.e., the P type DBR layer (p-DBR) and the N type DBR layer (n-DBR)) may be designed so that laser light is emitted from the top surface of the light-emitting element E or laser light is discharged from the bottom surface of the light-emitting element E.

In various embodiments of the present disclosure, the light-emitting element array EA may include multiple light-emitting elements E that are arranged on the base substrate S in a one- or two-dimensional way. The base substrate S may be made of GaAs, inP, sapphire (A1₂O₃), or InGaAs, and may be undoped, n-type-doped (e.g., doped with silicon (Si)) or p-type-doped (e.g., doped with zinc (Zn)).

In an embodiment of the present disclosure, the light-emitting element array EA may include the multiple light-emitting elements E in which the oxide opening OP (oxidation aperture) having substantially the same size has been formed in the lateral direction. In an embodiment of the present disclosure, the oxide opening OP (oxidation aperture) may be formed through the following process. As the AlGaAs layer is exposed to a high-temperature N₂ and H₂O (vapor) mixed gas atmosphere, H₂O molecules are subjected to a diffusion process within the AlGaAs layer. The AlGaAs material experiences an oxidation process of deforming the AlGaAs material into an AlOX:As form as the results of a chemical reaction with the AlGaAs material. The oxide opening OP may be formed through such processes. As conditions for the oxidation process, the Al content of the AlGaAs layer, the content of H₂O (vapor), or a temperature of a reaction chamber may be changed. A change in the conditions for the oxidation process induces a change in the lateral shape and size of the oxide opening OP.

A detailed embodiment of the present disclosure is described as follows. The light-emitting element E may include a base substrate S including first and second surfaces opposite to each other, an N type DBR layer (n-DBR) formed on the first surface (i.e., top surface) of the base substrate S, an active layer AR formed on the N type DBR layer (n-DBR), a P type DBR layer (p-DBR) formed on the active layer AR, a first electrode contact layer M1 electrically connected to the P type DBR layer (p-DBR), and a second electrode contact layer M2 formed on the second surface (i.e., bottom surface) of the base substrate S.

More specifically, the N type DBR layer (n-DBR) may be formed on the first surface (i.e., top surface) of the base substrate S. In an embodiment of the present disclosure, the N type DBR layer (n-DBR) may have a structure in which a pair of AlGaAs layers having different compositions are alternately formed or in which the GaAs layer and the AlGaAs layer are alternately stacked. In an embodiment of the present disclosure, the N type DBR layer (n-DBR) may include a pair of AlGaAs layers that are alternately stacked. Any one of the pair of AlGaAs layers may have a relatively higher aluminum (Al) composition than the other thereof. For example, the pair of AlGaAs layers may include an Al_{0.92}Ga_{0.08}As layer and an Al_{0.16}Ga_{0.84}As layer. The N type DBR layer (n-DBR) may be doped as an n-type because the N type DBR layer (n-DBR) includes silicon (Si) as impurities.

The N type DBR layer (n-DBR) may perform an internal reflection function under the active layer AR, and may supply n type carriers to the active layer AR. The active layer AR and the P type DBR layer (p-DBR) may be formed on the N type DBR layer (n-DBR).

The active layer AR may include AlInGaAs (i.e., AlInGaAs, GaAs, AlGaAs, and InGaAs), inGaAsP (i.e., inGaAsP, GaAs, inGaAs, GaAsP, and GaP), GaAsSb (i.e., GaAsSb, GaAs, and GaSb), inGaAsN (i.e., inGaAsN, GaAs, inGaAs, GaAsN, and GaN), or AlInGaAsP (i.e., AlInGaAsP, AlInGaAs, AlGaAs, inGaAs, inGaAsP, GaAs, inGaAs, GaAsP, and GaP), and may include a quantum well layer composition. In various embodiments of the present disclosure, the active layer AR may include one or more quantum well layers and barrier layers. The quantum well layer may include any one of GaAs, AlGaAs, AlGaAsSb, inAlGaAs, AlInGaP, GaAsP, or InGaAsP. The barrier layer may include any one of AlGaAs, inAlGaAs, inAlGaAsP, AlGaAsSb, GaAsP, GaInP, AlInGaP, or InGaAsP.

The P type DBR layer (p-DBR) may be formed on the active layer AR. The P type DBR layer (p-DBR) may be formed to have a structure in which a pair of AlGaAs layers having different compositions is alternately stacked or in which a GaAs layer and an AlGaAs layer are alternately stacked. In an embodiment of the present disclosure, the P type DBR layer (p-DBR) may include a pair of AlGaAs layers that are alternately stacked. Any one of the pair of AlGaAs layers may have a relatively higher aluminum (Al) composition than the other thereof. For example, the pair of AlGaAs layers may include an Al_{0.92}Ga_{0.08}As layer and an Al_{0.16}Ga_{0.84}As layer. In an embodiment of the present disclosure, the P type DBR layer (p-DBR) may be doped as a p-type because the P type DBR layer (p-DBR) includes carbon (C) or zinc (Zn) as impurities.

The first oxide layer O1 that defines the oxide opening OP may be formed within the P type DBR layer (p-DBR). In an embodiment of the present disclosure, the first oxide layer O1 may be formed at a location adjacent to the active layer AR in a stack direction in which the N type DBR layer (n-DBR), the active layer AR, and the P type DBR layer (p-DBR) are stacked on the base substrate S. In this case, if the first oxide layer O1 is formed at the location adjacent to the active layer AR, this may mean that the first oxide layer O1 is formed at a location relatively further adjacent to the active layer AR in the entire height of the P type DBR layer (p-DBR) in the stack direction. For example, it may mean that the first oxide layer O1 is formed at a location further adjacent to the bottom surface of the P type DBR layer (p-DBR), among the top surface of the P type DBR layer (p-DBR) that neighbors the first electrode contact layer M1 and the bottom surface of the P type DBR layer (p-DBR) that neighbors the active layer AR.

The first oxide layer O1 may concentrate carriers in the lateral direction. Carrier confinement may be performed by the first oxide layer O1 that is formed of relatively high electrical resistance so that the movement of carriers is limited. The first oxide layer O1 surrounds the oxide opening OP so that carriers preferentially move via the oxide opening OP. For example, an electrical resistance distribution and a refractive index distribution may be formed in the lateral direction via the first oxide layer O1 that surrounds the oxide opening OP. The density of carriers and photons may be increased within the active layer AR by the carrier confinement and optical confinement. As a result, laser light can be efficiently generated within the active layer AR.

In an embodiment of the present disclosure, the first oxide layer O1 that surrounds the oxide opening OP may be formed through the same process as the oxide opening OP. As conditions for the oxidation process, the Al content of the AlGaAs layer, the content of H₂O (vapor), or a temperature of a reaction chamber may be changed. A change in the conditions for the oxidation process induces a change in the lateral shape and size of the oxide opening OP.

In an embodiment of the present disclosure, in the oxidation process, a second oxide layer O2 within the P type DBR layer (p-DBR) may be formed in addition to the first oxide layer O1 that surrounds the oxide opening OP. For example, in an embodiment of the present disclosure, the second oxide layers O2 including oxide layers having different oxidation distances d2 and d3 may be alternately formed in the stack direction in the P type DBR layer (p-DBR) in which the AlGaAs layer having a relatively high ratio of aluminum and the AlGaAs layer having a relatively low ratio of aluminum are alternately stacked. For example, in an embodiment of the present disclosure, as will be described later, the oxidation distance d1, d2, d3 may mean a distance that extends from an etching part ET that is formed in the exposure region and/or exposed side of the light-emitting element E toward a central region of the light-emitting element E. For example, the oxidation distance d2 of the AlGaAs layer having a high ratio of aluminum may lengthily more extend toward the central region of the light-emitting element E than the oxidation distance d3 of the AlGaAs layer having a low ratio of aluminum.

Although not illustrated in the drawings, in an embodiment of the present disclosure, the first oxide layer O1 that surrounds the oxide opening OP may include multiple holes (not illustrated) through which the region of the first oxide layer O1 within the P type DBR layer (p-DBR) is exposed. In this case, as heated vapor oxidizes the oxide opening OP through the side of the exposed hole (not illustrated), the first oxide layer O1 that surrounds the oxide opening OP may be formed. In this case, the hole for exposing the side may be formed up to the depth of the region of the first oxide layer O1 of the P type DBR layer (p-DBR). When the light-emitting element E is exposed to the heated vapor in the oxidation process, the heated vapor may enter the hole and is radially diffused from the hole (not illustrated). When the heated vapor is diffused from each hole, oxidation interfaces may be merged, and oxidation processing may continue until the oxide opening OP is formed.

In an embodiment of the present disclosure, the light-emitting element E may include an ion implantation layer P for blocking the movement of a defect within the light-emitting element E. More specifically, the forming and/or movement of a defect within the light-emitting element E may increase optical absorption in the P type DBR layer (p-DBR) or the N type DBR layer (n-DBR) or may degrade electro optic properties in the active layer AR. In an embodiment of the present disclosure, a defect and/or a defect source which may degrade performance of the light-emitting element E may include the etching part ET formed in the oxide layer (i.e., the second oxide layer O2) of the light-emitting element E and the exposure region of the light-emitting element E. For example, as the AlGaAs layer is exposed to a high-temperature N₂ and H₂O (vapor) mixed gas atmosphere, H₂O (vapor) molecules experience a diffusion process within the AlGaAs layer. Accordingly, the AlGaAs material induces compression deformation according to a volume reduction caused by the AlGaAs material that is deformed in the AlOX:As form. Accordingly, the oxide layer (i.e., the second oxide layer O2) may form a compression deformation field.

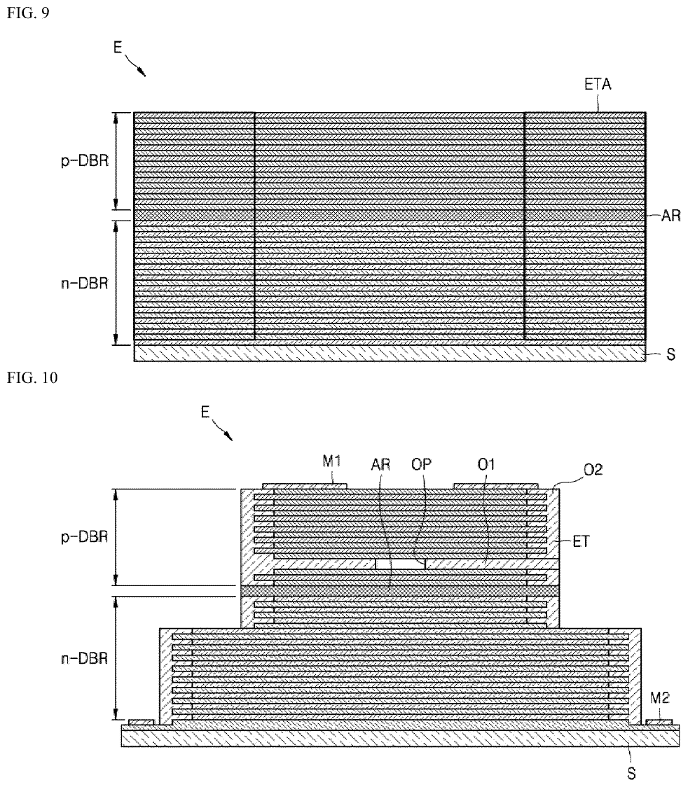

In an embodiment of the present disclosure illustrated in FIG. 4, the light-emitting element E may be formed in a double contact form in which different first and second electrode contact layers M1 and M2 are formed from the first and second surface sides of the base substrate S, respectively. For example, the P type DBR layer (p-DBR) and the N type DBR layer (n-DBR) adjacent to the P type DBR layer (p-DBR) may be etched down to be stepped with respect to the N type DBR layer (n-DBR) that is formed on the base substrate S and/or the first surface of the base substrate S (e.g., an etching region ETA illustrated FIG. 5). In this case, the side of the P type DBR layer (p-DBR) may correspond to the etching part ET formed in the exposure region as a defect and/or defect source of the light-emitting element E. As illustrated in FIG. 8, the light-emitting element E according to another embodiment of the present disclosure may be formed in a front contact form in which both different first and second electrode contact layers M1 and M2 are formed on the first surface (i.e., top surface) side of the base substrate S. Both the P type DBR layer (p-DBR) and the N type DBR layer (n-DBR) may be etched down to form a structure that is stepped by stages from the base substrate S (e.g., an etching region ETA illustrated in FIG. 9). The size of the P type DBR layer (p-DBR) or the N type DBR layer (n-DBR) may correspond to the etching part ET formed in the exposure region as a defect and/or defect source of the light-emitting element E. In such an embodiment, the first and second electrode contact layers M1 and M2 that are connected to the P type DBR layer (p-DBR) or the N type DBR layer (n-DBR) may be formed from the first surface (i.e., top surface) of the base substrate S on the P type DBR layer (p-DBR) and the base substrate S, respectively.

For example, the etching part ET may include a lattice defect having a crystal lattice or a defect that is induced by the remaining film after etching. For example, the etching part ET may include a line defect, such as dislocation, or a point defect, such as vacancy, as a lattice defect, and may include a defect that is induced by the remaining film after etching.

For example, the oxide layer (i.e., the second oxide layer O2) or the etching part ET as a defect and/or defect source that causes the degradation of performance of the light-emitting element E may induce deformation or stress within the structure of the light-emitting element E. Such a defect may cause the movement of a defect that moves toward the active layer AR during an operation of the light-emitting element E.

In an embodiment of the present disclosure, in order to block the movement of a defect, the light-emitting element E may include the ion implantation layer P in order to make a defect and/or a defect source insulated and/or non-conductive. In an embodiment of the present disclosure, the ion implantation layer P may be formed by an ion implantation method of disposing a mask (not illustrated) in which an opening pattern has been formed and projecting an ion beam including ion species onto a region corresponding to an opening pattern of the mask (not illustrated) by accelerating the ion beam. The implantation depth PD of the ion species and/or the depth PD of the ion implantation layer P may be adjusted depending on the weight of the implanted ion species or the amount of energy that accelerates the ion beam. In an embodiment of the present disclosure, in the ion implantation for forming the ion implantation layer P, ion species, such as H+, O+, N+, or F+, may be applied. For example, protons (H+) may be applied.

The ion implantation may make the ion implantation layer P insulated and/or non-conductive by inducing a lattice defect, such as vacancy, within the ion implantation layer P through the ion implantation. Accordingly, a bonding source covered by the ion implantation layer P, for example, the oxide layer (i.e., the second oxide layer O2) and the movement of a current or carriers toward a defect source, such as the etching part ET, can be suppressed. The movement of a defect from a defect source, such as the oxide layer (i.e., the second oxide layer O2) and the etching part ET, can be suppressed.

In an embodiment of the present disclosure, in the ion implantation, the implantation depth PD of the implanted ion species or the depth PD of the ion implantation layer P may be set as at least up to a lower area of the active layer AR that is out of the depth of the active layer AR. The implantation width of the implanted ion species in the lateral direction, the width of the opening pattern into which the ion species are implanted through the mask, or the width of the ion implantation layer P may be formed to be greater than the oxidation distance d2/d3 of the P type DBR layer (p-DBR) (e.g., the oxidation distance d2/d3 that relatively lengthily extends, among the oxidation distances d2 and d3 of the second oxide layers O2, for example, different oxidation distances d2 and d3 of the second oxide layers O2) and to be narrower than the first electrode contact layer M1 formed on the P type DBR layer (p-DBR). In other words, the implantation width of the implanted ion species or the width of the ion implantation layer P may be formed as a sufficiently wide width that covers all of the oxidation distances d2 and d3 of the P type DBR layer (p-DBR) (e.g., the oxidation distances d2 and d3 that relatively lengthily extend, among different oxidation distances d2 and d3 of the second oxide layers O2) and may also be formed as a sufficiently small width in which only a part of the first electrode contact layer M1 is covered so that an ohmic contact of the first electrode contact layer M1 is permitted. In an embodiment of the present disclosure, the width of the ion implantation layer P may be formed as a sufficiently narrow width in which only the edge region of the first oxide layer O1 that surrounds the oxide opening OP of a central region and the central region of the first oxide layer O1 that neighbors the oxide opening OP are not covered (because the oxide opening OP of the central region is a region for the concentration of carriers). The etching part ET and the second oxide layer O2 formed in the edge region may be formed to have a sufficiently great width in which both the edge region of the first oxide layer O1 and the central region of the first oxide layer O1 can be covered. For example, the ion implantation layer P may be formed in the edge region of the light-emitting element E, and may be formed to cover the etching part ET formed in the edge region of the light-emitting element E, all of the second oxide layers O2, and the edge region, that is, a part of the first oxide layer O1, but may not cover the central region of the first oxide layer O1 that surrounds the oxide opening OP. For example, the ion implantation layer P may not cover the oxide opening OP formed in the central region of the light-emitting element E formed in order to concentrate carriers and the central region of the first oxide layer O1 that neighbors the oxide opening OP.

The width of the ion implantation layer P or the width of the implanted ion species as described above may be formed to have a sufficiently small width in which the oxide opening OP for carrier confinement and optical confinement is not covered and the active layer AR (e.g., the central region of the active layer AR) having the density of carriers and photons increased by the oxide opening OP is not covered. More specifically, the width of the ion implantation layer P or the implantation width of the implanted ion species, for blocking the movement of a defect, may be defined between the inner end and outer end of the ion implantation layer P or the implantation width in the lateral direction. In this case, the inner end and outer end of the ion implantation layer P or the implantation width may refer to the ion implantation layer P relatively adjacent to the central region of the light-emitting element E and/or the oxide opening OP formed in the central region, the ion implantation layer P relatively distant from the inner end of the implantation width and the central region and/or the oxide opening OP formed in the central region, or the outer end of the implantation width. In an embodiment of the present disclosure, the ion implantation layer P or the implantation width may be formed from then outer end that covers the etching part ET formed in the exposure region of the light-emitting element E to the inner end between the outer end of the first electrode contact layer M1 and the inner end of the first electrode contact layer M1. In other words, the ion implantation layer P or the implantation width may be formed to cover a part of the first electrode contact layer M1 in the lateral direction, but to not fully cover the first electrode contact layer M1. In an embodiment of the present disclosure, the inner end of the ion implantation layer P or the implantation width may be formed between the inner end of the second oxide layer O2 and the inner end of the first oxide layer O1 (or the oxide opening OP that is defined by the inner end of the first oxide layer O1). Accordingly, the ion implantation layer P and/or the implantation width may be formed to cover only a part of the first oxide layer O1 while fully covering the second oxide layers O2 in the lateral direction. In an embodiment of the present disclosure, the outer end of the ion implantation layer P or the implantation width may be formed at the end location of the P type DBR layer (p-DBR) that is inward stepped in the lateral direction from the N type DBR layer (n-DBR) stacked on the base substrate S or the end location of the N type DBR layer (n-DBR) adjacent to the P type DBR layer (p-DBR).

In an embodiment of the present disclosure, the ion implantation layer P or the implantation width may be formed from the outer end that covers the etching part ET formed in the exposure region of the light-emitting element E to the inner end that is short of the oxide opening OP. The oxide opening OP may be formed at a location that does not overlap the ion implantation layer P or the implantation width so that the oxide opening OP is fully out of the ion implantation layer P or the implantation width. The oxide opening OP and/or the central region of the active layer AR corresponding to the oxide opening OP in the lateral direction may be formed at a location that is fully out of the ion implantation layer P or the implantation width so that the conductive properties of the oxide opening OP for carrier confinement and optical confinement and/or the central region of the active layer AR adjacent to the oxide opening OP are not degraded by ion implantation for forming the ion implantation layer P or the ion implantation layer P.

In an embodiment of the present disclosure, the width of the ion implantation layer P for suppressing the movement of a defect from a defect source, such as the oxide layer (i.e., the second oxide layer O2) and the etching part ET, to the active layer AR (e.g., the central region of the active layer AR in which carrier confinement and optical confinement are performed by the oxide opening OP) or the implantation width of the implanted ion species in the ion implantation may be formed to expose the central region of the active layer AR, but to cover the oxide layer (i.e., the second oxide layer O2) and the edge region of the active layer AR that neighbors the etching part ET. For example, if a defect moves from a defect source, such as the oxide layer (i.e., the second oxide layer O2) and the etching part ET, to the central region of the active layer AR and/or a location adjacent to the central region, performance of the light-emitting element E may be suddenly degraded and the function of the light-emitting element E may be substantially lost. Accordingly, in an embodiment of the present disclosure, although the conductive properties of a part of the active layer AR (e.g., the edge region of the active layer AR) are degraded or a part of the active layer AR (e.g., the edge region of the active layer AR) becomes insulated or non-conductive due to the ion implantation and/or the ion implantation layer P formed by the ion implantation, the implantation width and/or the ion implantation layer P that covers the edge region of the active layer AR that neighbors a defect source, such as the oxide layer (i.e., the second oxide layer O2) and the etching part ET, may be formed to block the movement of a defect. In an embodiment of the present disclosure, the depth PD or implantation depth PD of the ion implantation layer P may be set up to the lower area of the active layer AR. The ion implantation layer P may also cover the edge region of the active layer AR, while covering the edge region of the light-emitting element E in which the second oxide layer O2 or the etching part ET corresponding to a defect and/or a defect source is formed, when the depth PD or implantation depth PD of the ion implantation layer P that is deeply set up to the lower area of the active layer AR is considered.

In an embodiment of the present disclosure, the depth PD of the ion implantation layer P or the implantation depth PD of the implanted ion species in the ion implantation may refer to a depth at which an accelerated ion beam is projected, and may not include even a depth at which the ion species projected into the light-emitting element E are diffused after the projection, for example. Similarly, the width of the ion implantation layer P or the implantation width of the implanted ion species in the ion implantation may refer to a width in which the accelerated ion beam is projected into the light-emitting element through the opening pattern of the mask (not illustrated). For example, the width of the ion implantation layer P or the implantation width of the implanted ion species in the ion implantation may not include even a width in which the ion species projected into the light-emitting element E are diffused after the projection.

In an embodiment of the present disclosure, the depth PD of the ion implantation layer P or the implantation depth PD of the implanted ion species in the ion implantation for blocking the movement of a defect may be set as a sufficient depth up to the lower area of the active layer AR at least out of the active layer AR. A defect may be caused in a part of the active layer AR (e.g., the edge region of the active layer AR) via the ion implantation layer P that is formed in a sufficient depth up to the lower area of the active layer AR including the active layer AR. In this case, if a defect moves from the oxide layer (i.e., the second oxide layer O2) and the etching part ET to the active layer AR (e.g., the central region of the active layer AR in which carrier confinement and optical confinement are performed by the oxide opening OP), the function of the light-emitting element E may be substantially lost due to the sudden degradation of the active layer AR. Accordingly, in an embodiment of the present disclosure, although a part of the active layer AR (i.e., the edge region of the active layer AR) becomes insulated or non-conductive by the ion implantation layer P that covers a part of the active layer AR (i.e., the edge region of the active layer AR), the implantation depth PD of the ion implantation layer P or the ion implantation may be set as a sufficient depth up to the lower area of the active layer AR at least out of the active layer AR by considering the stable driving of the light-emitting element E according to time.

In a comparison example that is compared to the present disclosure, the first oxide layer O1 that surrounds the oxide opening OP is formed as follows. A mask (not illustrated) having an opening pattern corresponding to the oxide opening OP may be disposed. The oxide opening OP for carrier confinement and optical confinement may be formed by performing ion implantation that projects an ion beam including ion species onto a region corresponding to the opening pattern by accelerating the ion beam. In the comparison example in which the ion implantation is applied to the forming of the oxide opening OP (i.e., the first oxide layer O1 that surrounds the oxide opening OP) for carrier confinement and optical confinement as described above, the implantation depth PD of the implanted ion species and/or the implantation depth PD at which the accelerated ion beam is projected may be limited up to a depth that is short of the active layer AR. In contrast, in an embodiment of the present disclosure in which ion implantation is applied in order to suppress the movement of a defect from a defect source, such as the oxide layer (i.e., the second oxide layer O2) or the etching part ET, toward the active layer AR (i.e., the central region of the active layer AR in which carrier confinement and optical confinement are performed), the implantation depth PD of the ion implantation (or the depth PD of the ion implantation layer P) may be formed as a sufficient depth up to the lower area of the active layer AR at least out of the active layer AR. As in the comparison example, in the ion implantation for forming the oxide opening OP (i.e., the first oxide layer O1 that surrounds the oxide opening OP), a width in which the ion species are projected and/or the width of the opening pattern of the mask (not illustrated) onto which the ion beam including the ion species is projected may be set as the center of the central region corresponding to the oxide opening OP formed in the central region in the lateral direction. For example, as may be seen from FIG. 4, when the oxide opening OP has a structure in which the oxide opening is formed more on the inside than the inner end of the first electrode contact layer M1, in the ion implantation for forming the first oxide layer O1 that surrounds the oxide opening OP, a location at which conductivity is lost due to a defect may correspond to an inner location (i.e., the central region of the light-emitting element E) of the light-emitting element E in the lateral direction (like a location that is more inside than the inner end of the first electrode contact layer M1). As described above, in the comparison example in which the location of the ion implantation is relatively set as the central region, the implantation depth PD of the ion implantation may be set as a relatively thin depth that is short of the active layer AR so that the central region of the active layer AR in which carrier confinement and optical confinement are performed does not become insulated or non-conductive.

In other words, in the comparison example in which the ion implantation is applied in order to form the oxide opening OP, the implantation depth PD may be set as a relatively shallow depth that is short of the active layer AR in order to prevent the central region of the active layer AR from becoming insulated or non-conductive because the conductive properties of the active layer AR are degraded or the conductivity of the active layer AR is lost due to a lattice defect. Accordingly, in the comparison example, the implantation depth PD of the implanted ion species or the implantation depth PD at which the ion species are projected may be limited to an upper region of the active layer AR.

Unlike in the comparison example, in an embodiment of the present disclosure, the ion implantation is performed by setting the implantation width or the width of the ion implantation layer P through which the central region of the active layer AR is fully exposed. The central region of the active layer AR may not be degraded due to the ion implantation. Although the implantation depth PD is set as a sufficient depth up to the lower area of the active layer AR, the central region of the active layer AR may not be degraded. Furthermore, the implantation depth PD of the ion implantation may be set as a sufficient depth up to the lower area of the active layer AR so that the edge region (e.g., the oxide layer (i.e., the second oxide layer O2) and the etching part ET) of the active layer AR that neighbors a defect source becomes insulated or non-conductive by a defect (e.g., a lattice defect, such as vacancy) induced by the ion implantation.

In an embodiment of the present disclosure, the oxide opening OP may be formed through a separate oxidation process that is prior to the ion implantation for suppressing the movement of a defect. For example, in the oxidation process of forming the oxide opening OP, the oxide layers (i.e., the second oxide layers O2) having different oxidation distances d2 and d3 may be alternately formed in the stack direction depending on the aluminum content of each of layers (e.g., a sub array that forms the P type DBR layer (p-DBR)) that are stacked with respect to each other to form the P type DBR layer (p-DBR). For example, in the oxidation process, when the heated vapor is diffused into the light-emitting element E and reacts to the P type DBR layer (p-DBR), the second oxide layer O2 of the P type DBR layer (p-DBR) may be formed. Furthermore, as the heated vapor is radially diffused into via the exposed side of the hole (not illustrated) formed in the P type DBR layer (p-DBR), oxidation interfaces may be merged to form the first oxide layer O1 that surrounds the oxide opening OP. In an embodiment of the present disclosure, the oxidation distances d1, d2, and d3 of the first and second oxide layers O1 and O2 and/or the diffused distance of the heated vapor is determined by the aluminum content of each of layers that form the first and second oxide layers O1 and O2 or a separate diffusion acceleration structure, such as the hole (not illustrated) that facilitates the diffusion of the heated vapor. The first and second oxide layers O1 and O2 are formed within the P type DBR layer (p-DBR), and the first oxide layer O1 may be formed at the first oxidation distance d1 that is relatively long up to the central region of the light-emitting element E so that the first oxide layer O1 surrounds the oxide opening OP. The second oxide layer O2 may be formed at the oxidation distance d2 that is relatively short by being limited to the edge region of the light-emitting element E. For example, in an embodiment of the present disclosure, the second oxide layers O2 may have the second and third oxidation distances d2 and d3 that are different from each other in the stack direction, and may have the second and third oxidation distances d2 and d3 that are different from each other depending on the aluminum content of each of layers that are alternately stacked (i.e., a sub array that forms the P type DBR layer). In an embodiment of the present disclosure, the first to third oxidation distances d1, d2, and d3 may be measured from the edge region corresponding to the exposure region of the light-emitting element E. The first oxidation distance d1 of the first oxide layer O1 that surrounds the oxide opening OP may be the longest. The second and third oxidation distances d2 and d3 of the second oxide layers O2 may each be relatively shorter than the first oxidation distance d1. The second oxidation distance d2 may be relatively longer than the third oxidation distance d3 depending on the aluminum content of each of layers that are alternately stacked.

In an embodiment of the present disclosure, the first to third oxidation distances d1, d2, and d3 of the P type DBR layer (p-DBR) and the width of the ion implantation layer P or the implantation width of the ion implantation for suppressing the movement of a defect may have the following size relation. That is, when measured from the edge of the light-emitting element E that forms the exposure region of the light-emitting element E, the size relation between the first to third oxidation distances d1, d2, and d3 from the edge toward the central region and the implantation width may satisfy the relation of the first oxidation distance d1>the width of the ion implantation layer P or the implantation width>the second oxidation distance d2>the third oxidation distance d3. In other words, in an embodiment of the present disclosure, the implantation width of the ion implantation for suppressing the movement of a defect may be formed to sufficiently cover the second and third oxidation distances d2 and d3, to cover only the edge region of the first oxidation distance d1, and to expose the central region without covering the central region.

In an embodiment of the present disclosure, the depth PD of the ion implantation layer P or the implantation depth PD of the implanted ion species, for suppressing the movement of a defect, may be formed up to the lower area of the active layer AR out of the active layer AR. For example, the depth PD of the ion implantation layer P or the implantation depth PD of the ion species may be set up to a part of the N type DBR layer (n-DBR) under the active layer AR (i.e., an upper part of the N type DBR layer (n-DBR)) out of the active layer AR. In an embodiment of the present disclosure, the depth PD or implantation depth PD of the ion implantation layer P may be set as a shallower (or thinner) depth than the etched-down depth (refer to FIG. 5). If the depth PD or implantation depth PD of the ion implantation layer P is deeper than the etched-down depth, a lattice defect (such as vacancy attributable to the ion implantation) may be induced within the N type DBR layer (n-DBR) that is relatively distant from a defect source (such as the oxide layer (i.e., the second oxide layer O2) and the etching part ET). This may unnecessarily induce a defect attributable to the ion implantation in the N type DBR layer (n-DBR) that is relatively less severe than the P type DBR layer (p-DBR) having a relatively severe problem in which the recombination of minority carriers or the lifespan of minority carriers attributable to a defect is severe. For example, in an embodiment of the present disclosure, the etched-down depth may refer to a depth that includes the P type DBR layer (p-DBR) that is inward stepped in the lateral direction of the base substrate S from the N type DBR layer (n-DBR) stacked on the base substrate S and the N type DBR layer (n-DBR) that is adjacent to the P type DBR layer (p-DBR) and that is inward stepped along with the P type DBR layer (p-DBR).

In an embodiment of the present disclosure, the implantation depth PD of the implanted ion species may be formed up to the N type DBR layer (n-DBR) formed under the active layer AR, for example, because the implantation depth PD of the implanted ion species can be set up to the lower area of the active layer AR, and may be set up to a shallower (or thinner) depth than the etched-down depth of the N type DBR layer (n-DBR) that is inward stepped along with the P type DBR layer (p-DBR).

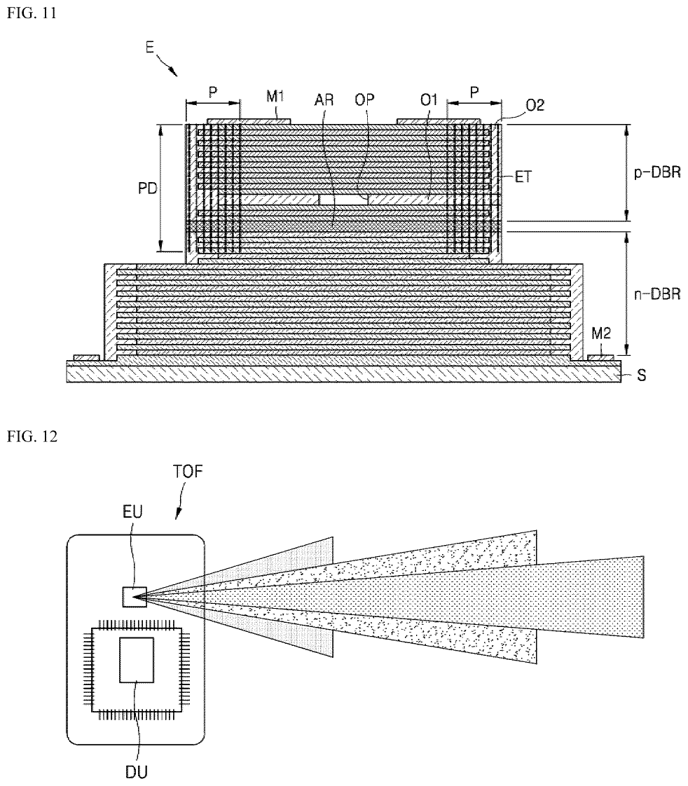

FIG. 8 is a diagram illustrating a cross-sectional structure of the light-emitting element E according to another embodiment of the present disclosure. FIGS. 9 to 11 are diagrams illustrating cross-sectional structures of the light-emitting elements E in different phases in which the light-emitting element E illustrated in FIG. 8 is formed.

Referring to FIGS. 8 to 11 in the light-emitting element E according to another embodiment of the present disclosure, the different first and second electrode contact layers M1 and M2 may be formed in a front contact form in which the electrode contact layer is formed from the first surface (i.e., top surface) side of the base substrate S. The P type DBR layer (p-DBR) or the N type DBR layer (n-DBR) may be etched down so that the P type DBR layer (p-DBR) and the N type DBR layer each form a structure that is stepped by stages from the base substrate S (refer to the etching region ETA in FIG. 9). In such an embodiment, the etching part ET may be formed in the exposure region of the P type DBR layer (p-DBR) or the N type DBR layer (n-DBR). The second oxide layers O2 that are alternately stacked at the different oxidation distances d2 and d3 from the etching part ET may be formed. For example, the N type DBR layer (n-DBR) may be formed by alternately stacking layers alternately consisting of the AlGaAs layer having a high ratio of aluminum and the AlGaAs layer having a high ratio of aluminum in the stack direction. The second oxide layers O2 may have different oxidation distances depending on the different aluminum content. The N type DBR layer (n-DBR) does not have a severe problem, such as that the recombination of minority carriers or the lifespan of minority carriers attributable to a defect is reduced, compared to the P type DBR layer (p-DBR), and does not have a great effect on the degradation of performance of the light-emitting element E. Accordingly, in an embodiment of the present disclosure, although the etching part ET and the second oxide layers O2 are formed in the exposure region of the N type DBR layer (n-DBR), the ion implantation layer P that covers the etching part ET and second oxide layers O2 of the N type DBR layer (n-DBR) may not be formed.

Referring to FIGS. 1 to 3, in an embodiment of the present disclosure, the light-emitting element array EA may include multiple light-emitting elements E that are arranged on the one base substrate S in the lateral direction. A passivation I may be formed including polyimide between the light-emitting elements E that are adjacent to each other along the array of the light-emitting element E. Through this specification, the exposure region of the light-emitting element E may refer to the boundary of the P type DBR layer (p-DBR) or N type DBR layer (n-DBR) of the light-emitting element E, and may include a boundary between the passivations I or the P type DBR layers (p-DBR) interposed between the light-emitting elements E that are adjacent to each other and a boundary between the passivations I and the N type DBR layers (n-DBR) interposed between the light-emitting elements E that are adjacent to each other, for example.

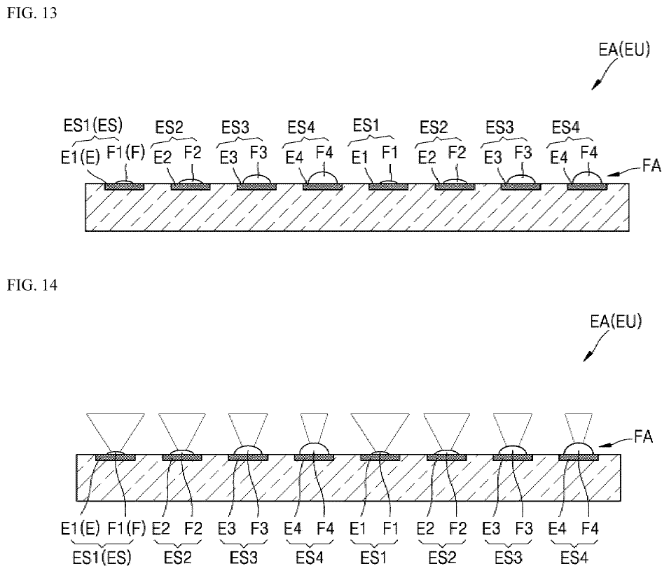

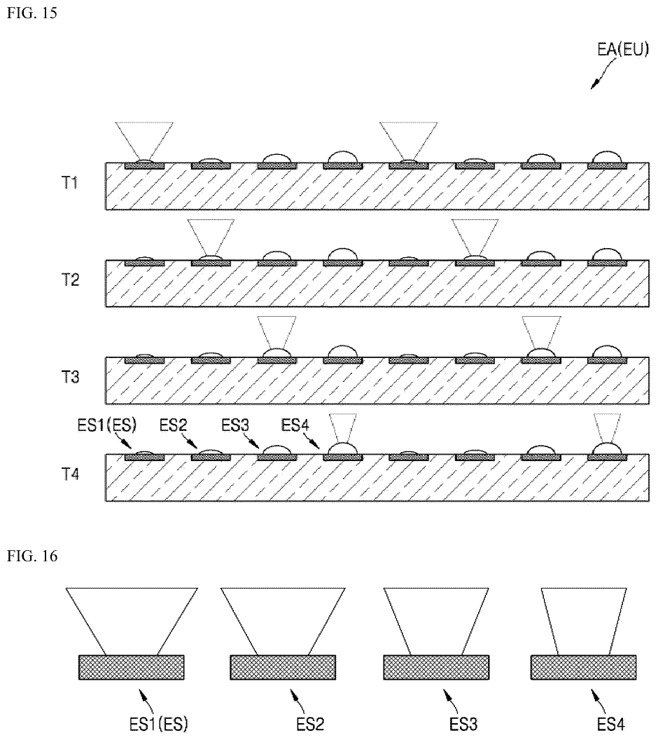

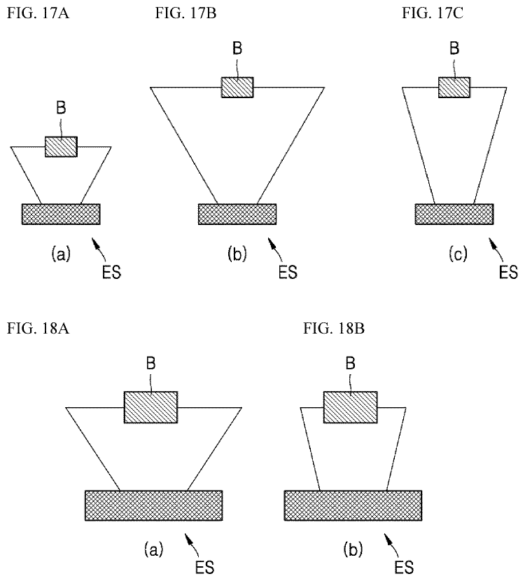

FIG. 12 is a diagram that schematically illustrates the TOF sensor TOF, including a light-emitting unit EU including multiple light-emitting elements E and a light-receiving unit DU including multiple light-receiving elements. FIG. 13 is a diagram illustrating a cross-sectional structure of the light-emitting unit EU including the optical lens array FA that is disposed in the light-emitting element array EA in an embodiment of the present disclosure. FIG. 14 is a diagram illustrating forms of lights that are output from the light-emitting unit EU illustrated in FIG. 13 and that provide different spot sizes (or different radiation angles) and visual fields. FIG. 15 is a diagram illustrating forms in which lights that provide different spot sizes (or different radiation angles) and visual fields are output according to time in a phase in which a first group of light-emitting element assemblies ES1 to a fourth group of light-emitting element assemblies ES4 are sequentially driven, for example, a phase in which the first group of light-emitting element assemblies ES1 to the fourth group of light-emitting element assemblies ES4 are driven at different times T1, T2, T3, and T4 in the light-emitting unit EU illustrated in FIG. 13. FIG. 16 is a diagram contrastedly illustrating forms of lights that are output from first to fourth groups of light-emitting element assemblies ES1, ES2, ES3, and ES4, respectively, and that provide different spot sizes (or different radiation angles) and visual fields in the light-emitting unit EU illustrated in FIG. 13. FIGS. 17A, 17B, and 17C illustrate a diagram for describing a construction that increases light intensity with the same spot size and a construction that reduces the spot size of light, as a construction for detecting an object at a long distance. FIGS. 18A and 18B illustrate a diagram for describing a construction that increases sensitivity with the same light intensity.

Referring to FIGS. 12 to 18B, in an embodiment of the present disclosure, the light-emitting element array EA and/or the light-emitting unit EU including the light-emitting element array EA detects a light transmission time when light is transmitted by the light-emitting element array EA and/or the light-emitting unit EU and a light reception time when the light-receiving unit DU including multiple light-receiving elements detects reflected light reflected by a surrounding object B. The light-emitting unit EU may form the TOF sensor TOF capable of detecting a distance and a location with respect to the surrounding object B according to a light flight distance. That is, the TOF sensor TOF may include both the light-emitting unit EU including the light-emitting element array EA and the light-receiving unit DU including the multiple light-receiving elements. The TOF sensor TOF according to an embodiment of the present disclosure may include the light-emitting unit EU (or the light-emitting element E) that emits light to a visual field around the TOF sensor and the light-receiving unit DU (or the light-receiving element) for detecting reflected light from the surrounding object B. The TOF sensor TOF may further include an operation processing unit (not illustrated) for calculating a light flight time corresponding to a time difference between a light transmission time and a light reception time, based on the time when the light-emitting unit EU transmits light and the time when the light-receiving unit DU detects light reflected by the surrounding object B, and calculating a distance up to the surrounding object B based on the light flight time. As will be described later, the light-emitting unit EU may include the light-emitting element array EA including the multiple light-emitting elements E and the optical lens array FA including the multiple optical lenses F arranged on the light-emitting element array EA. Technical contents of the optical lens F and/or the optical lens array FA are described in detail later.

In an embodiment of the present disclosure, the light-emitting element array EA may include first to fourth groups of light-emitting elements E1, E2, E3, and E4 that are each arranged in columns. First to fourth groups of optical lenses F1, F2, F3, and F4 for standardizing lights emitted from the light-emitting elements E, respectively, in different forms may be disposed on the first to fourth groups of light-emitting elements E1, E2, E3, and E4, respectively. In an embodiment of the present disclosure, the first to fourth groups of light-emitting elements E1, E2, E3, and E4 may mean a group of light-emitting elements E that share an address line A that applies power so that the light-emitting elements are electrically connected and driven. Likewise, the first to fourth groups of optical lenses F1, F2, F3, and F4 may be a group of optical lenses F disposed on the first to fourth groups of light-emitting elements E1, E2, E3, and E4 that share the address line A. The first to fourth groups of light-emitting elements E1, E2, E3, and E4 and the first to fourth groups of optical lenses F1, F2, F3, and F4 may have the same array on the base substrate S. The light-emitting element array EA and the optical lens array FA disposed on the light-emitting element array EA may form the light-emitting unit EU. Each light-emitting element E and each optical lens F disposed on each light-emitting element E may form a light-emitting element assembly ES. In this sense, the light-emitting unit EU according to an embodiment of the present disclosure may include the first to fourth groups of light-emitting elements E1, E2, E3, and E4, may include the first to fourth groups of optical lenses F1, F2, F3, and F4 along with the first to fourth groups of light-emitting elements E1, E2, E3, and E4, and may include first to fourth groups of light-emitting element assemblies ES1, ES2, ES3, and ES4 including the light-emitting elements E and the optical lenses F.

In an embodiment of the present disclosure, the light-emitting unit EU may include the first group of light-emitting element assemblies ES1, the second group of light-emitting element assemblies ES2, the third group of light-emitting element assemblies ES3, and the fourth group of light-emitting element assemblies ES4 that emit lights that have been standardized in different forms in order to provide different spot sizes and visual fields. In an embodiment of the present disclosure, when the light-emitting unit EU includes the first group of light-emitting element assemblies ES1, the second group of light-emitting element assemblies ES2, the third group of light-emitting element assemblies ES3, and the fourth group of light-emitting element assemblies ES4 that emit lights standardized in different forms, this may mean that the first to fourth groups of light-emitting element assemblies emit different lights standardized to have different radiation angles so that the first to fourth groups of light-emitting element assemblies have different spot sizes at the same optical axis distance along an optical axis thereof or emit lights standardized to have different spot sizes so that the first to fourth groups of light-emitting element assemblies have different light intensities at the same optical axis distance along the optical axis.

As will be described later, the first group of light-emitting element assemblies ES1 may include the first group of light-emitting elements E1 and the first group of optical lenses F1 arranged on the optical axis of the first group of light-emitting elements E1. The second group of light-emitting element assemblies ES2 may include the second group of light-emitting elements E2 and the second group of optical lenses F2 disposed on the optical axis of the second group of light-emitting elements E2. Likewise, the third group of light-emitting element assemblies ES3 may include the third group of light-emitting elements E3 and the third group of optical lenses F3 disposed on the optical axis of the third group of light-emitting elements E3. Furthermore, the fourth group of light-emitting element assemblies ES4 may include the fourth group of light-emitting elements E4 and the fourth group of optical lenses F4 disposed on the optical axis of the fourth group of light-emitting elements E4.

In an embodiment of the present disclosure, the first to fourth groups of light-emitting elements E1, E2, E3, and E4 may have substantially the same structure and the same performance. The first to fourth groups of optical lenses F1, F2, F3, and F4 may standardize lights emitted from the first to fourth groups of light-emitting elements E1, E2, E3, and E4 in different forms.

In an embodiment of the present disclosure, the first group of light-emitting element assemblies ES1 detects the location of the surrounding object B that is captured in a short-distance visual field around the TOF sensor TOF based on a distance from the surrounding object B to be captured by the light-emitting unit EU and/or the TOF sensor TOF including the light-emitting unit EU. The fourth group of light-emitting element assemblies ES4 detects the location of the surrounding object B that is captured in a long-distance visual field around the TOF sensor TOF. Each of the second and third groups of light-emitting element assemblies ES2 and ES3 provides a middle-distance visual field that is longer than the short-distance visual field of the first group of light-emitting element assemblies ES1 and that is shorter than the long-distance visual field of the fourth group of light-emitting element assemblies ES4 between a short distance and a long distance around the TOF sensor TOF based on a distance from the surrounding object B to be captured by the TOF sensor TOF. For example, the second group of light-emitting element assemblies ES2 may have a visual field set between the short-distance and long-distance visual fields of the first and fourth groups of light-emitting element assemblies ES1 and ES4, and may provide a short-distance visual field closer to the short-distance visual field of the first group of light-emitting element assemblies ES1 than to the long-distance visual field of the fourth group of light-emitting element assemblies ES4. The third group of light-emitting element assemblies ES3 may have a visual field set between the short-distance and long-distance visual fields of the first and fourth groups of light-emitting element assemblies ES1 and ES4, and may provide a long-distance visual field closer to the long-distance visual field of the fourth group of light-emitting element assemblies ES4 than to the short-distance visual field of the first group of light-emitting element assemblies ES1.

In an embodiment of the present disclosure, the light-emitting element assembly ES may include the optical lens F disposed on the light-emitting element E in the direction of the optical axis of the light-emitting element E or the direction of the top surface of the light-emitting element E. The optical lens F may include the first to fourth groups of optical lenses F1, F2, F3, and F4 disposed on the first to fourth groups of light-emitting elements E1, E2, E3, and E4, respectively. For example, the first group of optical lenses F1 may standardize a light emitted from the first group of light-emitting elements E1 as a light that has a relatively wide spot size (e.g., the widest spot size, among the spot sizes of the first to fourth groups of optical lenses) and/or a light with a relatively wide spot size, where the light intensity is distributed, is limited to the shortest short-distance visual field. The fourth group of optical lenses F4 may standardize a light emitted from the fourth group of light-emitting elements E4 as light that has a relatively narrow spot size (e.g., the narrowest spot size, among the spot sizes of the first to fourth groups of optical lenses) and/or a light the light intensity is concentrated at a relatively narrow spot size and that is expanded to the longest long-distance visual field. Furthermore, each of the second and third groups of optical lenses F2 and F3 may standardize a light emitted from each of the second and third groups of light-emitting elements E2 and E3 as a light that has a narrower spot size than the first group of optical lenses F1 and that has a wider spot size than the fourth group of optical lenses F4. More specifically, the second group of optical lenses F2 may standardize a light emitted from the second group of light-emitting elements E2 as a light having a relatively wide spot size so that the spot size of the light is closer to the spot size of the first group of optical lenses F1 than to the spot size of the fourth group of optical lenses F4. The third group of optical lenses F3 may standardize a light emitted from the third group of light-emitting elements E3 as a light having a relatively narrow spot size so that the spot size of the light is closer to the spot size of the fourth group of optical lenses F4 than to the spot size of the first group of optical lenses F1.

In an embodiment of the present disclosure, the spot size of the second group of optical lenses F2 may be wider than the spot size of the third group of optical lenses F3. The visual field of the second group of optical lenses F2 may be formed to be shorter than the visual field of the third group of optical lenses F3.

In an embodiment of the present disclosure, the first to fourth groups of optical lenses F1, F2, F3, and F4 may each maintain sufficient light intensity even at a long distance because the spot size of each optical lens is gradually reduced from the first group of optical lenses F1 toward the fourth group of optical lenses F4 and the light intensity thereof is concentrated on a reduced spot size. Accordingly, the first to fourth groups of optical lenses F1, F2, F3, and F4 may each provide a visual field from a long distance to a short distance gradually from the first group of optical lenses F1 to the fourth group of optical lenses F4. For example, the first to fourth groups of optical lenses F1, F2, F3, and F4 may be formed to gradually have greater curvature or refractive power from the first group of optical lenses F1 to the fourth group of optical lenses F4.

As illustrated in FIG. 16, the first to fourth groups of light-emitting element assemblies ES1, ES2, ES3, and ES4 may each maintain sufficient light intensity even at a long distance more smoothly from the first group of light-emitting element assemblies ES1 to the fourth group of light-emitting element assemblies ES4, and may each gradually provide a visual field from a short distance to a long distance.

As illustrated in FIGS. 17A, 17B, 17C, in order for a light emitted from the light-emitting element assembly ES to be reflected by the surrounding object B disposed at a long distance with sufficient light intensity and to be detected by the light-receiving unit DU with high sensitivity, the light-emitting element assembly ES may operate in a way to have the same spot size as in FIG. 17A, but to raise light intensity as in FIG. 17B. In contrast, the light-emitting element assembly ES may have the same light intensity as in FIG. 17A, but may reduce the spot size of reflected light reflected by the surrounding object B at a long distance so that the reflected light is reflected with sufficient light intensity and detect the reflected light with high sensitivity by using the light-receiving unit DU. For example, in an embodiment of the present disclosure, the reason why a long-distance visual field is provided gradually from the first group of light-emitting element assemblies ES1 to the fourth group of light-emitting element assemblies ES4 is that the first to fourth groups of optical lenses F1, F2, F3, and F4 are constructed to have gradually greater curvature and/or gradually higher refractive power so that the same light intensity is concentrated on a relatively narrow spot size as in FIG. 17C.

Referring to FIGS. 18A and 18B, as in FIG. 18A, a light having a relatively wide spot size forms relatively low light intensity of reflected light from the surrounding object B at the same distance while being distributed at a spot size having wide light intensity. In contrast, as in FIG. 18(b), a light having a relatively narrow spot size form relatively high light intensity of reflected light from the surrounding object B at the same distance while being concentrated on a spot size having narrow light intensity. A form of the light illustrated in FIG. 18B may provide relatively higher sensitivity than a form of the light illustrated in FIG. 18A.

For example, as illustrated in FIGS. 17A through 18B, in order to recognize the object, if it is necessary to increase light intensity of reflected light or if it is necessary to increase sensitivity, it may be advantageous to output light having a narrow spot size. To this end, it may be advantageous to increase curvature or refractive power of the optical lens F.

In an embodiment of the present disclosure, a dense visual field for a short distance around the TOF sensor TOF may be provided (e.g., densely detect an external object in an overlapping visual field without gaps, with overplapping spot sizes relative to each other, by using a wide radiation angle of the first group of light-emitting element assemblies ES1 that are adjacently disposed to each other) by selectively driving the first group of light-emitting element assemblies ES1 to which the first group of optical lenses F1 has been applied while simultaneously applying the first to fourth groups of optical lenses F1, F2, F3, and F4 having different optical properties. A visual field for a long distance around the TOF sensor TOF may be provided by driving the fourth group of light-emitting element assemblies ES4 to which the fourth group of optical lenses F4 has been selectively applied. A visual field for a middle distance around the TOF sensor TOF may be provided by selectively driving the second group of light-emitting element assemblies ES2 or the third group of light-emitting element assemblies ES3.

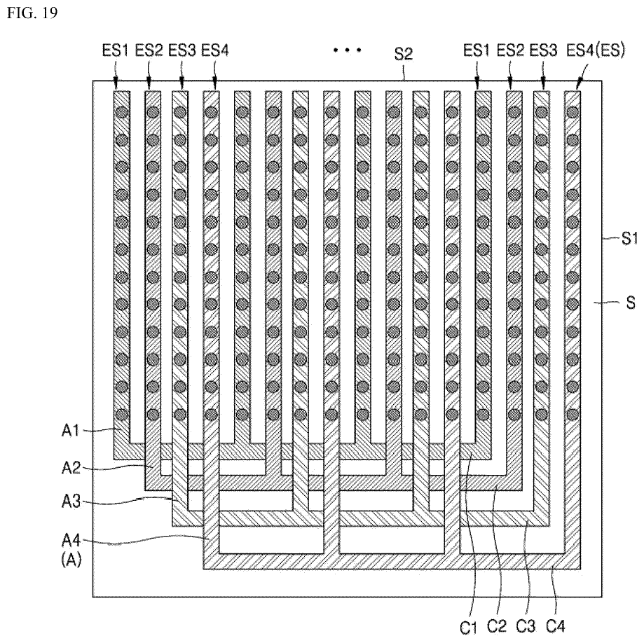

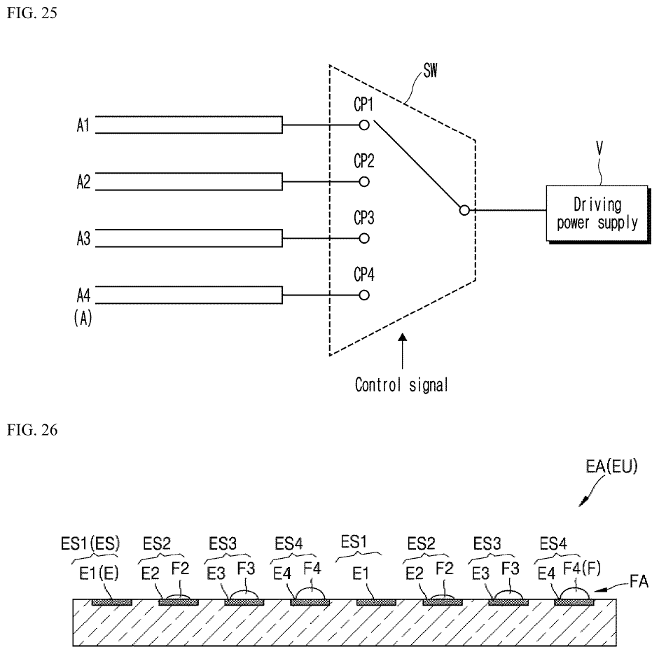

FIGS. 19 to 24 illustrate diagrams for describing address structures of the light-emitting units EU having different address structures for independently applying driving power supplies V to the first to fourth groups of light-emitting element assemblies ES1, ES2, ES3, and ES4. FIG. 25 illustrates a diagram for describing an embodiment in which a switching operation is implemented between first to four contact points CP1, CP2, CP3, and CP4 connected to first to fourth groups of address lines A1, A2, A3, and A4, respectively, and the driving power supply V.

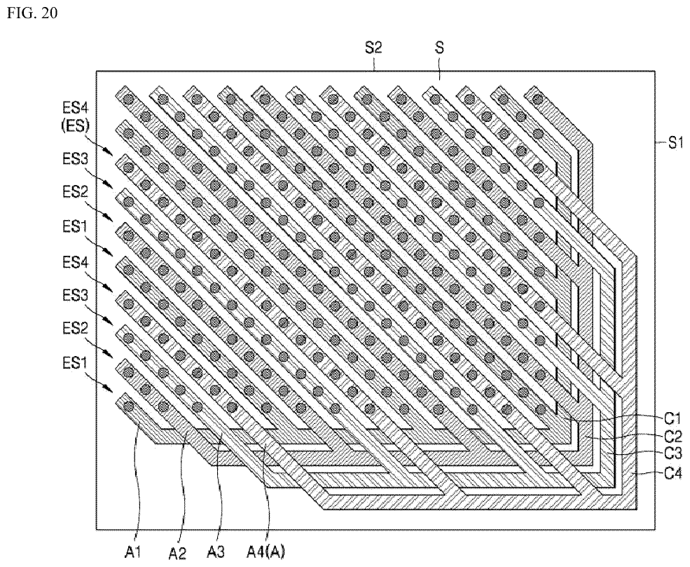

Referring to FIGS. 19 and 20, in an embodiment of the present disclosure, the first to fourth groups of optical lenses F1, F2, F3, and F4 or the first to fourth groups of light-emitting element assemblies ES1, ES2, ES3, and ES4 may have gradually different optical properties. The first to fourth groups of light-emitting element assemblies ES1, ES2, ES3, and ES4 having optical properties gradually changed may be sequentially arranged in the lateral direction of the base substrate S. As will be described later, the first to fourth groups of light-emitting element assemblies ES1, ES2, ES3, and ES4 may be connected to first to fourth groups of address lines A1, A2, A3, and A4 that separately apply the driving power supplies V. For example, the first to fourth groups of light-emitting element assemblies ES1, ES2, ES3, and ES4 may perform switching operations of sequentially connecting the first to fourth groups of address lines A1, A2, A3, and A4 and the driving power supplies V so that the light-emitting unit EU and/or the TOF sensor TOF including the light-emitting unit EU can sequentially change spot sizes and visual field distances according to time. Furthermore, the first to fourth groups of address lines A1, A2, A3, and A4 and/or the first to fourth groups of light-emitting element assemblies ES1, ES2, ES3, and ES4 connected to the first to fourth groups of address lines A1, A2, A3, and A4, respectively, may be sequentially arranged so that switching operations between the first to fourth groups of address lines A1, A2, A3, and A4 that are different from each other can be sequentially performed.

As illustrated in FIGS. 19 and 20, in an embodiment of the present disclosure, the first to fourth groups of light-emitting elements E1, E2, E3, and E4 may be circularly alternately arranged on the base substrate S in the lateral direction. As will be described later, the first to fourth groups of address lines A1, A2, A3, and A4 connected to the first to fourth groups of light-emitting elements E1, E2, E3, and E4 may also be circularly alternately arranged on the base substrate S in the lateral direction. That is, the first to fourth groups of light-emitting elements E1, E2, E3, and E4 may be circularly alternately arranged on the base substrate S in order of the first group of light-emitting elements E1—the second group of light-emitting elements E2—the third group of light-emitting elements E3—the fourth group of light-emitting elements E4—the first group of light-emitting elements E1. Likewise, the first to fourth groups of address lines A1, A2, A3, and A4 may also be circularly alternately arranged in order of the first group of address lines A1—the second group of address lines A2—the third group of address lines A3—the fourth group of address lines A4—the first group of address lines A1. For example, in an embodiment of the present disclosure, the first to fourth groups of optical lenses F1, F2, F3, and F4 may be formed so that curvature or refractive power is gradually increased from the first group of optical lenses F1 to the fourth group of optical lenses F4. For example, the first group of optical lenses F1 may standardize a light that is emitted at a great radiation angle from the first group of light-emitting elements E1 as a light having a relatively high radiation angle and a wide spot size (i.e., a light having the widest spot size) while refracting the emitted light with relatively low refractive power. The fourth group of optical lenses F4 may standardize a light that is emitted at a great radiation angle from the fourth group of light-emitting elements E4 as a light having a relatively low radiation angle and a narrow spot size (i.e., a light having the narrowest spot size) while refracting the emitted light with relatively high refractive power.

In an embodiment of the present disclosure, the first to fourth groups of optical lenses F1, F2, F3, and F4 may each function as a condensing lens that condenses a light that is output in a form in which the light is emitted from each of the first to fourth groups of light-emitting elements E1, E2, E3, and E4 centering around the optical axis. In another embodiment of the present disclosure, in order to differentiate forms of lights output from the first to fourth groups of light-emitting elements E1, E2, E3, and E4, the optical lens F may not be disposed on the light-emitting element E of any one of the first to fourth groups of light-emitting elements E1, E2, E3, and E4.

The first to fourth groups of light-emitting element assemblies ES1, ES2, ES3, and ES4 having optical properties gradually changed may be sequentially arranged in the lateral direction of the base substrate S. As will be described later, the first to fourth groups of light-emitting element assemblies ES1, ES2, ES3, and ES4 may be connected to the first to fourth groups of address lines A1, A2, A3, and A4 for separately applying the driving power supplies V. For example, switching operations of sequentially connecting the first to fourth groups of address lines A1, A2, A3, and A4 and the driving power supplies V may be performed so that the light-emitting unit EU and/or the TOF sensor TOF including the light-emitting unit EU can sequentially change a spot size and a visual field distance according to time. The first to fourth groups of address lines A1, A2, A3, and A4 and/or the first to fourth groups of light-emitting element assemblies ES1, ES2, ES3, and ES4 connected to the first to fourth groups of address lines A1, A2, A3, and A4 may be sequentially be arranged so that switching operations between the first to fourth groups of address lines A1, A2, A3, and A4 that are different from each other can be sequentially performed.

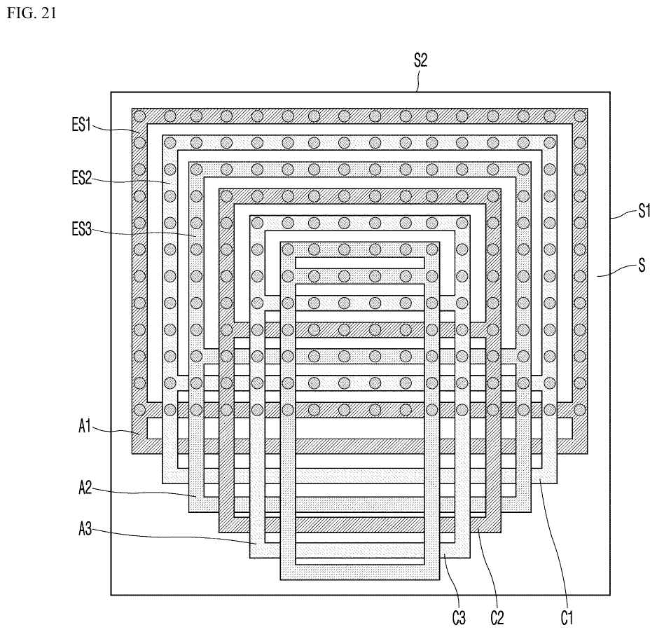

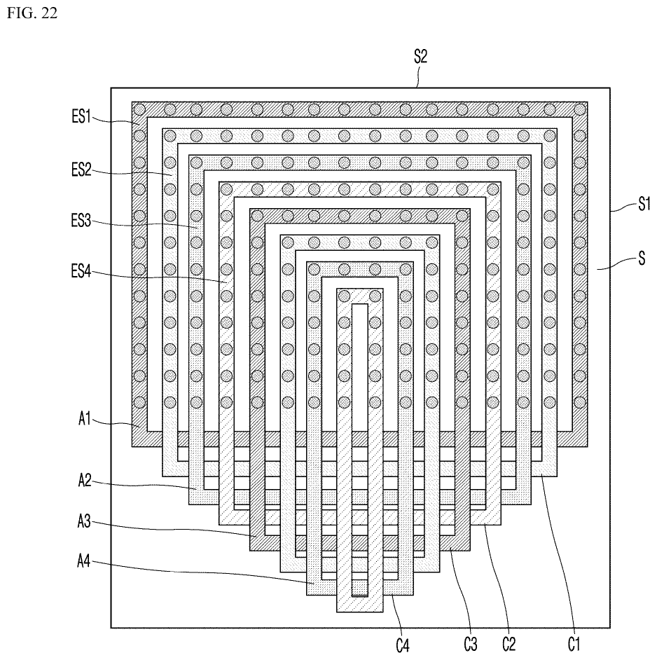

The first to third groups of light-emitting element assemblies ES1, ES2, and ES3 or the first to fourth groups of light-emitting element assemblies ES1, ES2, ES3, and ES4 may be sequentially arranged as described above. As illustrated in FIG. 21, the light-emitting element assemblies ES1 to ES3 or ES1 to ES4 include all of the aforementioned characteristics, but may each be arranged in a rectangular form. Alternatively, the light-emitting element assemblies ES1 to ES3 or ES1 to ES4 are sequentially arranged, but may each be arranged in a rectangular form in which one surface of each light-emitting element assembly is opened, not a rectangular form, as illustrated in FIG. 22.

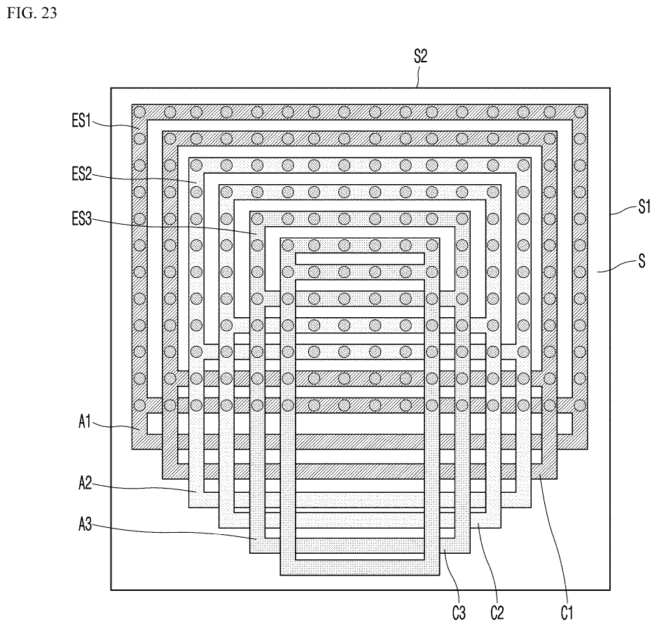

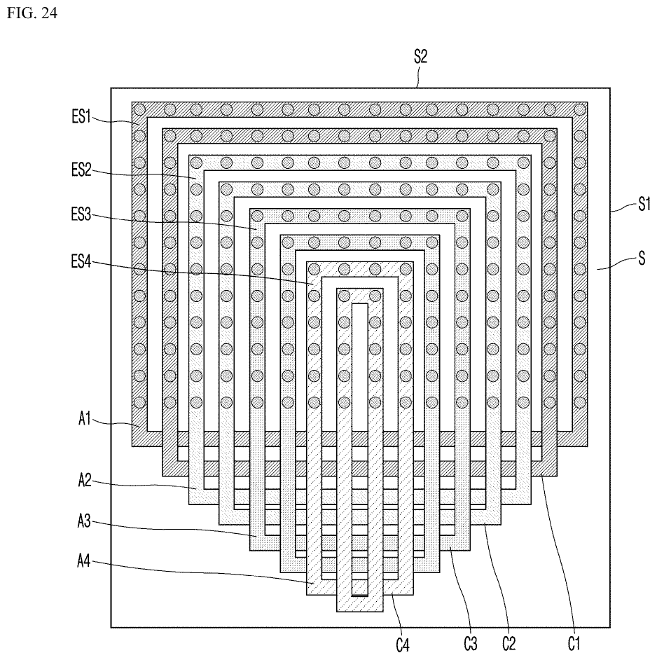

The first to third groups of light-emitting element assemblies ES1, ES2, and ES3 or the first to fourth groups of light-emitting element assemblies ES1, ES2, ES3, and ES4 include all of the aforementioned characteristics, but may each be arranged as illustrated in FIG. 23 or 24. As illustrated in FIG. 23, the first group of light-emitting element assemblies ES1 may be arranged in a rectangular form on the outermost side of the address structure of the light-emitting unit or on the inside right adjacent to the outermost side. The second group of light-emitting element assemblies ES2 may be arranged in a rectangular form on the inside of the first group of light-emitting element assemblies ES1. The third group of light-emitting element assemblies ES3 may be arranged in a rectangular form on the inside of the second group of light-emitting element assemblies ES2. The three groups have been illustrated as being arranged in FIG. 23, but the present disclosure is not essentially limited thereto. The number of groups of arranged light-emitting element assemblies may be different according to circumstances.

In this case, a light-emitting element assembly that need to radiate a light with a relatively higher output, such as radiating the light at the longest distance, are arranged in the first group of light-emitting element assemblies ES1 that is arranged on the relatively outermost side. Light-emitting elements are arranged inward from the first group of light-emitting element assemblies ES1 in order of relatively lower power. The light-emitting element that radiates a light with a relatively higher output essentially emits a relatively large amount of heat. If such a light-emitting element is disposed in a central part of the base substrate S, a problem in that other light-emitting elements or another light-emitting element assembly that is adjacent (in the outermost direction) to the light-emitting elements is adversely effected, heat is not smoothly discharged to the outside or a lot of time is taken to discharge the heat, and a heat dome is formed therein may be caused. In order to solve such problems, the first group of light-emitting element assemblies ES1 is arranged on the relatively outermost side. Accordingly, heat that is generated as a corresponding assembly operates can be smoothly discharged to the outside, and the influence of the heat on another assembly in the discharge process can be minimized. Furthermore, when considering the speed at which heat is discharged a location relation between assemblies, the occurrence of a heat dome phenomenon in which heat remains without being smoothly discharged, in particular, a heat dome phenomenon in which heat is generated in the central part can be minimized. The first to third groups of light-emitting element assemblies ES1, ES2, and ES3 may be connected to the address lines A1, A2, A3, and A4 as described above with reference to FIG. 19.

As illustrated in FIG. 24, the first to fourth groups of light-emitting element assemblies ES1 to ES4 are arranged in the same way as that illustrated in FIG. 23 in which the light-emitting element assembly that needs to radiate a light with the highest output is disposed on the outermost side and the remaining light-emitting element assemblies are arranged inward in order of relatively lower output, but may be arranged in a rectangular form in which each light-emitting element assembly has one surface opened not a rectangular form. Accordingly, each of the first to fourth groups of light-emitting element assemblies ES1 to ES4 may be connected to the address lines A1, A2, A3, and A4 in an easy and simplified circuit form.

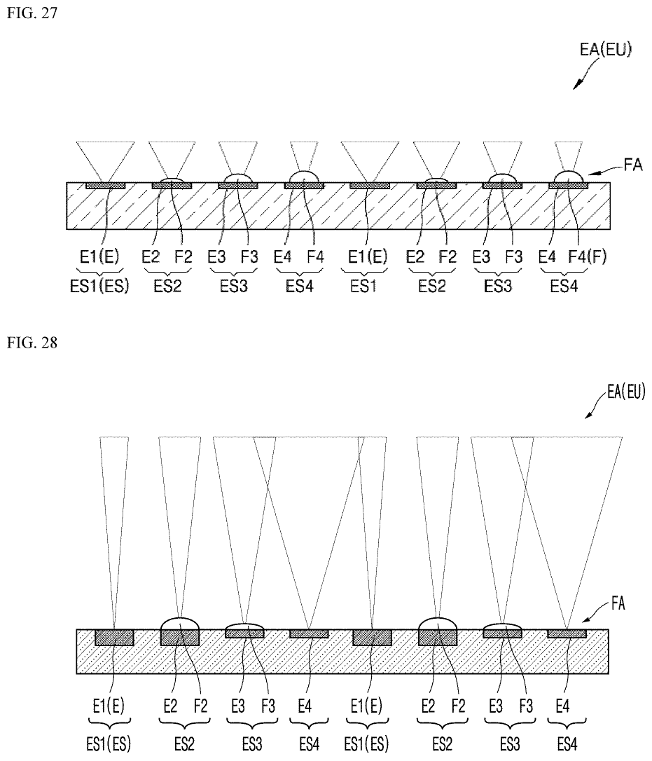

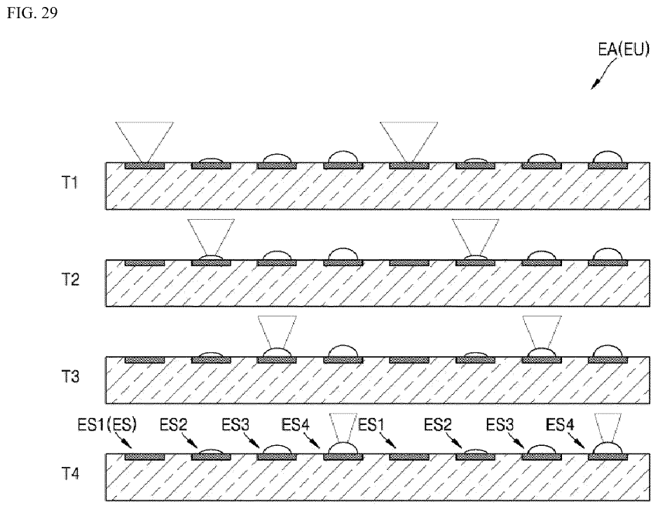

FIG. 26 is a diagram illustrating a cross-sectional structure of a light-emitting unit EU including the optical lens array FA disposed in the light-emitting element array EA in another embodiment of the present disclosure. FIG. 27 is a diagram illustrating forms of lights that are output from the light-emitting unit EU illustrated in FIG. 25 and that provide different spot sizes (or radiation angles) and visual fields. FIG. 28 is a diagram illustrating different forms of lights that are output from the light-emitting unit EU illustrated in FIG. 26. FIG. 29 is a diagram illustrating forms in which lights that provide different spot sizes (or different radiation angles) and visual fields are output according to time in a phase in which a first group of light-emitting element assemblies ES1 to a fourth group of light-emitting element assemblies ES4 are sequentially driven, for example, a phase in which the first group of light-emitting element assemblies ES1 to the fourth group of light-emitting element assemblies ES4 are driven at different times T1, T2, T3, and T4 in the light-emitting unit EU illustrated in FIG. 26.

Referring to FIGS. 26 to 29, in another embodiment of the present disclosure, the optical lens F may not be disposed on the first group of light-emitting elements E1 so that a light having a form in which light intensity is distributed to a wide range at a relatively great spot size (i.e., a light having the widest spot size) is standardized. That is, since the optical lens F that condenses a light output from the first group of light-emitting elements E1 is not disposed on the first group of light-emitting elements E1, a light having a relatively wide spot size may be output compared to the second to fourth groups of light-emitting element assemblies ES2, ES3, and ES4 on each of which the optical lens F basically functioning as a condensing lens is disposed. As described above, the optical lens F may not be disposed on the first group of light-emitting elements E1. The second to fourth groups of optical lenses F2, F3, and F4 may be disposed on the second to fourth groups of light-emitting elements E2, E3, and E4, respectively. The second to fourth groups of optical lenses F2, F3, and F4 may be formed to have gradually higher curvature or refractive power.

According to this specification, the meaning that the first to fourth groups of light-emitting element assemblies ES1, ES2, ES3, and ES4 provide lights having gradually changing spot sizes may encompass a structure in which the optical lens F is not disposed on any one light-emitting element E, among the first to fourth groups of light-emitting elements E1, E2, E3, and E4, rather than limitedly meaning that the first to fourth groups of optical lenses F1, F2, F3, and F4 are disposed on the first to fourth groups of light-emitting elements E1, E2, E3, and E4, respectively. For example, the optical lens F may not be disposed on the first light-emitting element E that provides a light having the widest spot size, among the first to fourth groups of light-emitting elements E1, E2, E3, and E4. The first to fourth groups of light-emitting element assemblies ES1, ES2, ES3, and ES4 may provide lights having gradually changing spot sizes. For example, the first group of light-emitting element assemblies ES1 may not include the first group of optical lenses F1. In a broad sense, the first group of light-emitting elements E1 and/or the first group of light-emitting element assemblies ES1 may be formed to have substantially the same structure. As will be described later, in various embodiments of the present disclosure, the optical lens F that is disposed on the light-emitting element E may include first and second condensing lenses L1 and L2 disposed to overlap so that optical interference is possible with respect to each other. Even in such an embodiment, the first group of optical lenses F1 including the first and second condensing lenses L1 and L2 disposed to overlap may not be disposed on the first group of light-emitting elements E1, to the same effect as the first group of optical lenses F1 being not disposed on the first group of light-emitting elements E1. For example, although the first and second condensing lenses L1 and L2 disposed to overlap so that optical interference is possible with respect to each other are disposed on each of the second to fourth groups of light-emitting elements E2, E3, and E4, the first and second condensing lenses L1 and L2 disposed to overlap may not be disposed on the first group of light-emitting elements E1.

In an embodiment of the present disclosure, the first to fourth groups of optical lenses F1, F2, F3, and F4 (e.g., the second to fourth groups of optical lenses F2, F3, and F4 if the first group of optical lenses F1 is excluded, the same as below) each having a form in which curvature or refractive power is gradually increased may be disposed on the first to fourth groups of light-emitting elements E1, E2, E3, and E4, respectively. In this case, the first to fourth groups of optical lenses F1, F2, F3, and F4 may be disposed on top surfaces of the first to fourth groups of light-emitting elements E1, E2, E3, and E4. For example, the first to fourth groups of optical lenses F1, F2, F3, and F4 may be supported on the first to fourth groups of light-emitting elements E1, E2, E3, and E4.

As illustrated in FIG. 27, in order to make different the spot sizes of lights output from the first to fourth groups of light-emitting element assemblies ES1 to ES4 or the first to fourth groups of light-emitting elements E1 to E4 included in the first to fourth groups of light-emitting element assemblies ES1 to ES4, the radiation angles of the first to fourth groups of light-emitting elements E1 to E4 themselves may be additionally adjusted without being limited to only whether the first to fourth groups of optical lenses F1 to F4 are included or a change in the type of optical lenses. For example, a light-emitting element assembly (e.g., ES1 or ES2 in FIG. 27) that needs to output a light having a relatively narrow radiation angle because the light-emitting element assembly has to radiate the light at a long distance may radiate a light so that a light-emitting element (e.g., E1 or E2 in FIG. 27) itself has a relatively narrow radiation angle, separately from the adjustment of the radiation angle by using the optical lens. In contrast, a light-emitting element assembly (e.g., ES3 or ES4 in FIG. 27) that needs to output a light having a relatively wide radiation angle because the light-emitting element assembly has to radiate the light at a short distance may radiate a light so that a light-emitting element (e.g., E3 or E4 in FIG. 27) itself has a relatively wide radiation angle. Accordingly, each of the first to fourth groups of light-emitting element assemblies ES1 to ES4 can adjust the radiation angle of output light more finely by adjusting the radiation angle of each of the first to fourth groups of light-emitting elements E1 to E4 themselves and curvature or refractive power of each of the first to fourth groups of optical lenses F1 to F4 disposed on light paths thereof.

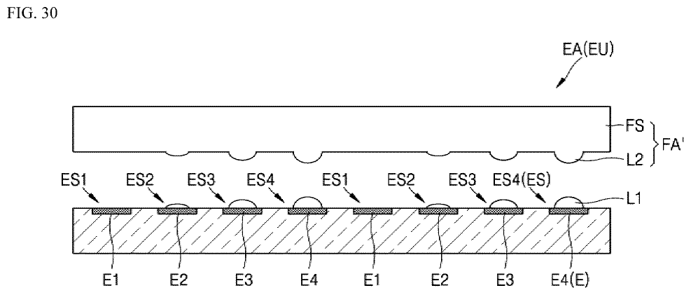

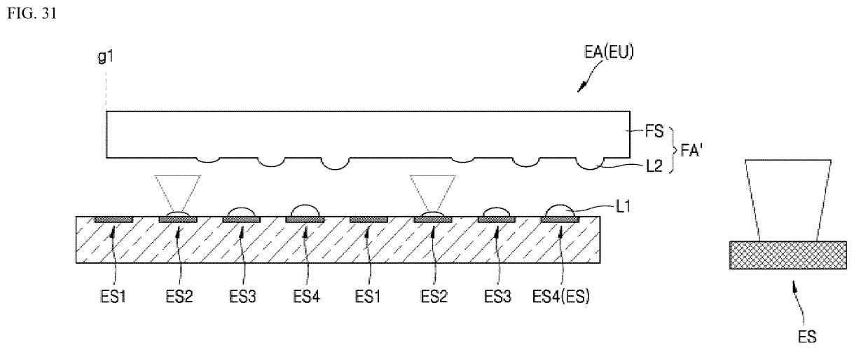

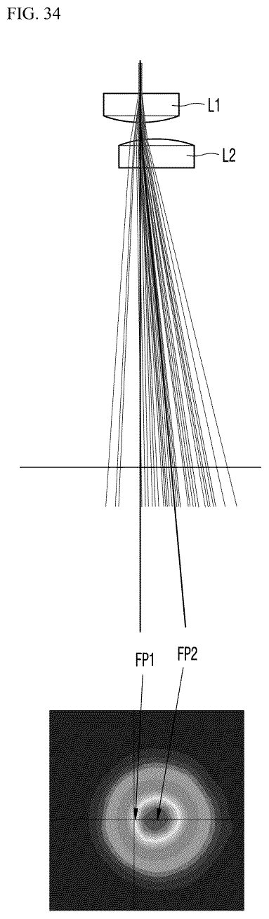

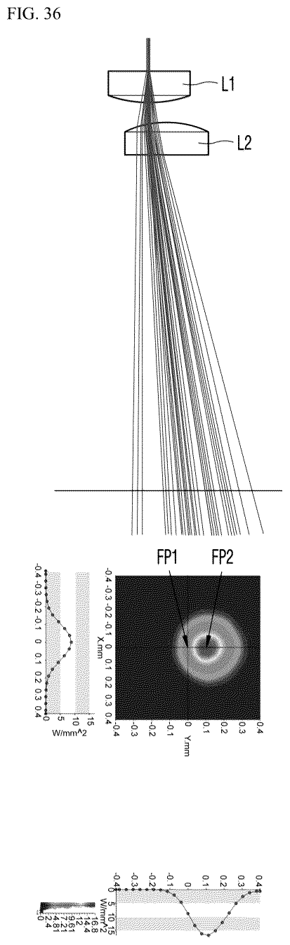

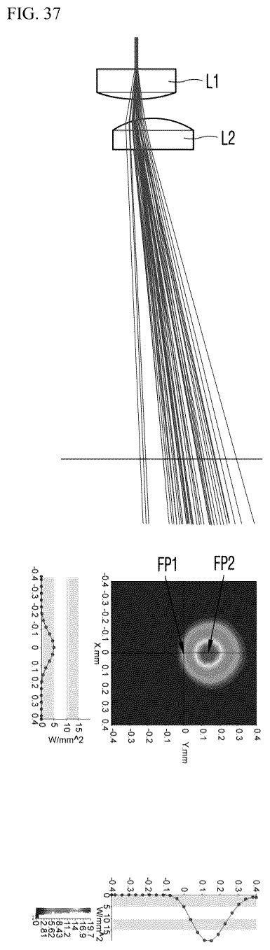

FIG. 30 is a diagram illustrating a cross-sectional structure of the light-emitting unit EU including an overlap arrangement of the first condensing lens L1 supported on the light-emitting element E and the second condensing lens L2 spaced apart from the light-emitting element E in another embodiment of the present disclosure. FIGS. 31 to 33 are diagrams illustrating lights that have different forms and that are provided from the light-emitting unit EU at different first to third locations g1, g2, and g3 of the second condensing lens L2 for the first condensing lens L1 in the light-emitting unit EU illustrated in FIG. 30. FIGS. 34 to 37 are diagrams illustrating forms of lights that are biased at different degrees from the center of the first condensing lens L1 toward the center of the second condensing lens L2 through different curvature or refractive power or different optical arrangements of the first and second condensing lenses L1 and L2 in the light-emitting unit EU illustrated in FIG. 30.

Referring to FIGS. 30 to 37, in an embodiment of the present disclosure, the first to fourth groups of optical lenses F1, F2, F3, and F4 (e.g., the second to fourth groups of optical lenses F2, F3, and F4 if the first group of optical lenses F1 is excluded) may each include the first and second condensing lenses L1 and L2 disposed to overlap so that optical interference is possible with respect to each other. Before such an embodiment is described in detail, a modified embodiment of the present disclosure is described with reference to the drawings.

That is, in the modified embodiment of the present disclosure, the first to fourth groups of optical lenses F1, F2, F3, and F4 may be disposed on the optical axes of the first to fourth groups of light-emitting elements E1, E2, E3, and E4, respectively, although the first to fourth groups of optical lenses F1, F2, F3, and F4 are not supported on the first to fourth groups of light-emitting elements E1, E2, E3, and E4. For example, each of the first to fourth groups of optical lenses F1, F2, F3, and F4 may generate proper refractive power with respect to a light output from each of the first to fourth groups of light-emitting elements E1, E2, E3, and E4 on the optical axis of each of the first to fourth groups of light-emitting elements E1, E2, E3, and E4. Each of the first to fourth groups of optical lenses F1, F2, F3, and F4 (e.g., the second to fourth groups of optical lenses F2, F3, and F4 if the first group of optical lenses F1 is excluded) may be disposed on the optical axis of each light-emitting element E, and may be supported at the height at which each group of optical lenses is spaced apart from the light-emitting element E by a proper support structure. In various embodiments of the present disclosure, the first to fourth groups of optical lenses F1, F2, F3, and F4 may be prepared as an integrated optical lens array FA in which the first to fourth groups of optical lenses F1, F2, F3, and F4 have been integrally connected. The integrated optical lens array FA may be made of an optically transparent optical material. For example, as illustrated in FIG. 27, the integrated optical lens array FA may include a flat support FS and the first to fourth groups of optical lenses F1, F2, F3, and F4 (e.g., the second to fourth groups of optical lenses F2, F3, and F4 if the first group of optical lenses F1 is excluded) formed at locations corresponding to the optical axes of the first to fourth groups of light-emitting elements E1, E2, E3, and E4, respectively, on the bottom surface of the support FS, which faces the first to fourth groups of light-emitting elements E1, E2, E3, and E4. In an embodiment of the present disclosure, the second to fourth groups of optical lenses F2, F3, and F4 may be formed in a form in which the first group of optical lenses F1 has been excluded. The second to fourth groups of optical lenses F2, F3, and F4 may be formed in a form in which the second to fourth groups of optical lenses F2, F3, and F4 have been connected by the support FS. The first group of optical lenses F1 may be formed in a flat form in which curvature is substantially zero. The second to fourth groups of optical lenses F2, F3, and F4 may each be formed in a form in which curvature is gradually increased.

As illustrated in FIG. 30, in an embodiment of the present disclosure, each of the first to fourth groups of optical lenses F1, F2, F3, and F4 (e.g., each of the second to fourth groups of optical lenses F2, F3, and F4 if the first group of optical lenses F1 is excluded) may include the first and second condensing lenses L1 and L2 that are disposed to overlap so that optical interference is possible with respect to each other and that are disposed at different heights along the optical axis of each of the first to fourth groups of light-emitting elements E1, E2, E3, and E4. For example, the spot size of a light that is output in an emitted form from the light-emitting element E may be reduced as the light is condensed centering around the optical axis via the first condensing lens L1. The spot size of the light may be further reduced as the light is condensed once again centering around the optical axis via the second condensing lens L2 that is disposed subsequently to the first condensing lens L1. That is, in an embodiment of the present disclosure, the spot size of the light may be successively reduced while overlappingly passing through the first and second condensing lenses L1 and L2 formed at different heights along the optical axis. For example, a visual field that is expanded at a long distance with a relatively reduced spot size can be provided, compared to the embodiment in which only any one of the first condensing lens L1 having a form in which the first condensing lens L1 is supported on the light-emitting element E and the second condensing lens L2 (i.e., the second condensing lens L2 constructed in the form of the integrated optical lens array FA) supported at a height spaced apart from the light-emitting element E. It is possible to provide a visual field at a longer distance around the TOF sensor TOF depending on an overlap arrangement of the first and second condensing lenses L1 and L2. The TOF sensor TOF can detect the location of the surrounding object B disposed at a longer distance through the first and second condensing lenses L1 and L2 each providing a visual field at a long distance.

Referring to FIGS. 31 to 33, in an embodiment of the present disclosure, the first and second condensing lenses L1 and L2 may be aligned so that the optical axes of the first and second condensing lenses L1 and L2 are matched with the optical axis of the light-emitting element E. It is possible to provide a light having a form in which an optical axis location FP having the highest light intensity is not changed, by the first and second condensing lenses L1 and L2 disposed to have the optical axes aligned with the optical axis of the light-emitting element E as described above (e.g., a second location g2 of the second condensing lens L2). For example, an optical axis location FP2 (refer to FIG. 34) of a light that sequentially passes through the first and second condensing lenses L1 and L2 may be matched with an optical axis location FP1 (refer to FIG. 34) of a light that passes through only the first condensing lens L1 and/or the optical axis location FP of the light-emitting element E.

In various embodiments of the present disclosure, the first and second condensing lenses L1 and L2 may be disposed to have the optical axes cross each other (e.g., a third location g3 of the second condensing lens L2). By the arrangement of the first and second condensing lenses L1 and L2 disposed to have the optical axes cross each other, a biased light that is changed differently from a light provided from the location of the optical axis of the light-emitting element E or the optical axis location FP1 of the first condensing lens L1 supported on the light-emitting element E may be provided from the optical axis location FP2 having the highest light intensity. For example, in an embodiment of the present disclosure, the light-emitting element E and the optical axis of the first condensing lens L1 may be aligned (i.e., the second location g2 of the second condensing lens L2). The optical axes of the first and second condensing lenses L1 and L2 may be disposed to cross each other (i.e., the third location g3 of the second condensing lens L2). In such an embodiment, the first and second condensing lenses L1 and L2 having the optical axes aligned may provide a light that is not changed (i.e., the second location g2 of the second condensing lens L2) at the optical axis locations FP1 and FP2. Alternatively, the first and second condensing lenses L1 and L2 having the optical axes disposed to cross each other may provide a changing biased light (e.g., a biased light at the optical axis location FP2 directed toward the center of the second condensing lens L2 while passing through the second condensing lens L2) at the optical axis locations FP1 and FP2. More specifically, the optical axis of a light that is output from the first condensing lens L1 may be biased toward the center of the second condensing lens L2 while passing through the second condensing lens L2. The optical axis location FP2 of a light that is output from the second condensing lens L2 may provide a biased light toward the center of the second condensing lens L2 centering around the optical axis of the light-emitting element E and/or the optical axis of the first condensing lens L1 while the light passes through the second condensing lens L2.

For example, in the embodiment in which the first and second condensing lenses L1 and L2 are disposed to cross each other (i.e., the third location g3 of the second condensing lens L2) so that a biased light is provided with respect to the optical axis of the light-emitting element E and/or the optical axis of the first condensing lens L1 supported on the light-emitting element E, the center of the first and second condensing lenses L1 and L2 and/or an optical center (i.e., the optical axis locations FP1 and FP2) may be spaced apart from each other along the top surface of the light-emitting element E or in a direction that crosses the optical axis. The center of the first and second condensing lenses L1 and L2 and/or the optical center (i.e., the optical axis locations FP1 and FP2) may be disposed to be spaced apart from each other and to at least partially overlap. The first and second condensing lenses L1 and L2 may form optical interference between the first and second condensing lenses L1 and L2 by such an arrangement of the first and second condensing lenses L1 and L2 disposed to cross each other (e.g., the third location g3 of the second condensing lens L2). Each condensing lens can provide a biased light toward the center of the second condensing lens L2 while providing a visual field at a relatively long distance, by the overlap arrangement of the first and second condensing lenses L1 and L2 each functioning as a condensing lens.

In an embodiment of the present disclosure, the optical lens array FA in which the second condensing lens L2 and/or the second condensing lens L2 have been arranged (e.g., the integrated optical lens array FA in which the multiple second condensing lenses L2 have been integrally connected) may be supported to enable a translation motion in a direction parallel to the top surface of the light-emitting element E from which a light is output. By the translation motion of the optical lens array FA, the optical lens array FA can move the second condensing lens L2 between the different first to third locations g1, g2, and g3. Accordingly, the optical lens array FA may change the properties of a light that is output from the light-emitting element E and/or the TOF sensor TOF including the light-emitting element E. For example, according to the translation motion of the optical lens array FA which is performed between the first to third locations g1, g2, and g3, as illustrated in FIG. 28, the TOF sensor TOF may provide a light having a relatively wide spot size by using the first condensing lens L1 at the first location g1 at which the second condensing lens L2 has fallen outside the first condensing lens L1. Furthermore, as illustrated in FIG. 29, the TOF sensor TOF may provide a light having a spot size that is more reduced than a spot size at the first location g1 and provide a visual field having a more extended long distance, at the second location g2 at which the optical axis of the second condensing lens L2 is matched with the optical axis of the first condensing lens L1, that is, at the second location g2 at which the optical axes of the first and second condensing lenses L1 and L2 are aligned. Furthermore, as illustrated in FIG. 30, the TOF sensor TOF may provide a light that is more biased centering around the second condensing lens L2 at the second location g2, at the third location g3 at which the optical axis of the second condensing lens L2 is disposed to cross the optical axis of the first condensing lens L1, that is, at the third location g3 at which the optical axes of the first and second condensing lenses L1 and L2 cross each other. The TOF sensor TOF may provide lights having different forms, by the second condensing lens L2 supported to enable the translation motion between the different first to third locations g1, g2, and g3 in the direction parallel to the top surface of the light-emitting element E from which a light is output and/or the optical lens array FA in which the second condensing lens L2 has been arranged as described above.

In an embodiment of the present disclosure, the optical lens F may not be disposed on the first light-emitting element E that provides the widest spot size. For example, the first and second condensing lenses L1 and L2 may not be disposed on the first light-emitting element E. In such an embodiment, as illustrated in FIGS. 28 to 30, although the second condensing lens L2 and/or the optical lens array FA in which the second condensing lens L2 has been arranged performs a translation motion between the first to third locations g1, g2, and g3, the second condensing lens L2 as well as the first condensing lens L1 may not be disposed on the first light-emitting element E. In this case, in various embodiments of the present disclosure, at the first location g1, the second condensing lens L2 may not be disposed on the first light-emitting element E. However, at the second location g2 and the third location g3, the second condensing lens L2 may be disposed on the first light-emitting element E. In such an embodiment, the first and second condensing lenses L1 and L2 may be overlappingly disposed on the second to fourth light-emitting elements E2, E3, and E4. In contrast, only the second condensing lens L2 may be disposed on the first light-emitting element E without the first condensing lens L1, and may standardize a light that is output from the first light-emitting element E as a light having a further reduced spot size (or a visual field expanded at a long distance).

In an embodiment of the present disclosure, as the optical axes of the first and second condensing lenses L1 and L2 cross each other (i.e., the third location g3 of the second condensing lens L221), the optical axis location FP of the first condensing lens L1 and/or the highest location of light intensity of a light that passes through the first condensing lens L1 may be biased toward the center of the second condensing lens L2. Accordingly, a light that is output from the light-emitting element E and/or the TOF sensor TOF including the light-emitting element E may be biased. The TOF sensor TOF according to an embodiment of the present disclosure may be mounted on a transport robot which may travel in an autonomous driving mode. In this case, a light output direction from the TOF sensor TOF may need to be biased depending on the direction in which the transport robot on which the TOF sensor TOF is mounted travels and the location where the TOF sensor TOF is mounted. For example, it may be necessary to bias a light output direction from the TOF sensor TOF at a direction change time when the travel direction of the transport robot will be changed and/or prior to the direction change time and to detect whether an obstacle, that is, the surrounding object B, is present and the location of the surrounding object B in the changed direction.

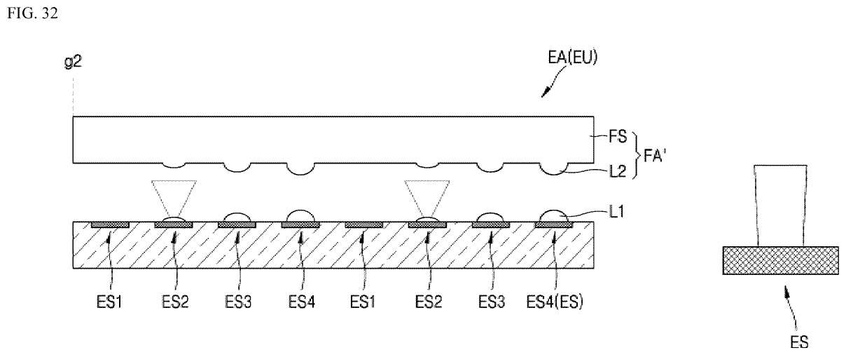

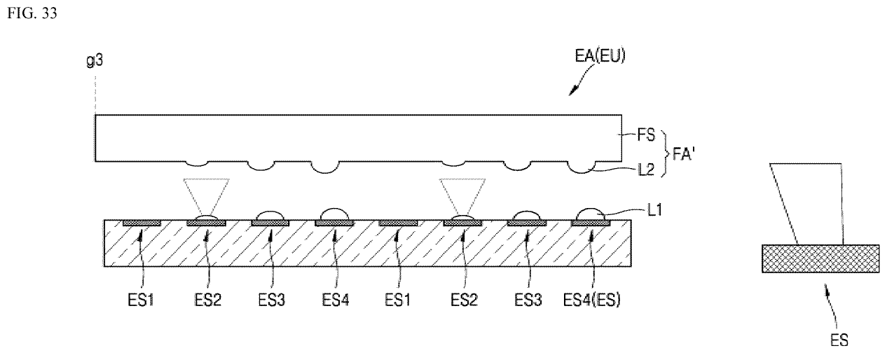

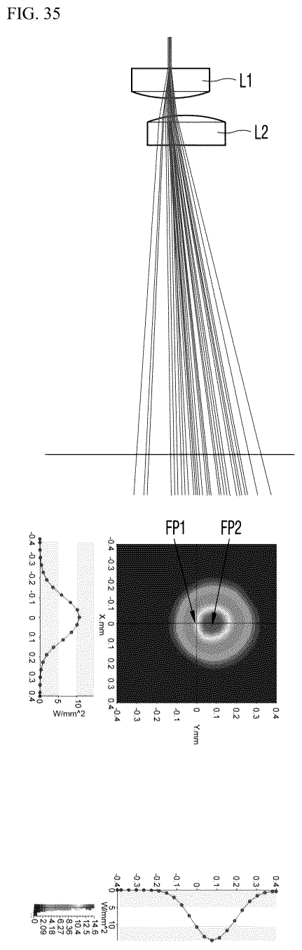

As illustrated in FIGS. 34 to 37, the optical axis of a light that passes through the first condensing lens L1 may be biased toward the center of the second condensing lens L2 by using the arrangement in which the first and second condensing lenses L1 and L2 cross each other (i.e., the third location g3 of the second condensing lens L2). The optical axis location FP and/or the location at which the intensity of a light is the highest may be captured at a location that is biased from the optical axis location FP of the first condensing lens L1. For example, a bias degree at which the optical axis location FP2 (i.e., the optical axis location FP2 of a light that is output from the second condensing lens L2) is biased from the optical axis location FP1 of the first condensing lens L1 may be different depending on the separation degree of the optical axes of the first and second condensing lenses L1 and L2 or a detailed design of the first and second condensing lenses L1 and L2, such as pieces of curvature or refractive power of the first and second condensing lenses L1 and L2 (e.g., a difference between the pieces of curvature or refractive power of the first and second condensing lenses L1 and L2). For example, FIGS. 32 to 34 illustrate the results of simulations for measuring a degree that the optical axis location FP2 (i.e., an optical axis location at which light intensity is the highest) of a light that passes through the first and second condensing lenses L1 and L2 is biased from the optical axis location FP1 of the first condensing lens L1 toward the center of the second condensing lens L2, when the centers of the first and second condensing lenses L1 and L2 are disposed to cross each other by 50 μm or the optical axes of the first and second condensing lenses L1 and L2 are disposed to cross each other by 50 μm. In the simulations of FIG. 32, when curvature of the first condensing lens L1 is 3 and curvature of the second condensing lens L2 is 3, the angle at which the optical axes and/or optical axis locations FP2 of the first and second condensing lenses L1 and L2 are biased from the optical axis and/or optical axis location FP1 of the first condensing lens L1 is 5.1 degrees. In the simulations of FIG. 33, when curvature of the first condensing lens L1 is 3 and curvature of the second condensing lens L2 is 4, the angle at which the optical axes and/or optical axis locations FP2 of the first and second condensing lenses L1 and L2 are biased from the optical axis and/or optical axis location FP1 of the first condensing lens L1 is 6.7 degrees. In the simulations of FIG. 34, when curvature of the first condensing lens L1 is 3 and curvature of the second condensing lens L2 is 5, the angle at which the optical axes and optical axis locations FP2 of the first and second condensing lenses L1 and L2 are biased from the optical axis and/or optical axis location FP1 of the first condensing lens L1 was calculated as 8.4 degrees. From the results of the simulations of FIGS. 32 to 34, it may be seen that the angle at which an optical axis is biased may be different depending on the angle at which the optical axes and/or centers of the first and second condensing lenses L1 and L2 cross each other (e.g., in FIGS. 35 to 37, 50 μm by which the optical axes and/or centers of the first and second condensing lenses L1 and L2 cross each other) and curvature of each of the first and second condensing lenses L1 and L2 (e.g., the curvature of 3 to 5 in FIGS. 35 to 37).

Referring to FIGS. 19 to 26, the light-emitting unit EU according to an embodiment of the present disclosure may include the address line A for selectively turning on/off any one light-emitting element assembly ES, among the first to fourth groups of light-emitting element assemblies ES1, ES2, ES3, and ES4. For example, the light-emitting unit EU according to an embodiment of the present disclosure may include the first to fourth groups of address lines A1, A2, A3, and A4 that are electrically connected to the first to fourth groups of light-emitting element assemblies ES1, ES2, ES3, and ES4, respectively, so that driving lines are provided to the first to fourth groups of light-emitting element assemblies ES1, ES2, ES3, and ES4 individually or selectively. For example, in an embodiment of the present disclosure, the first to fourth groups of address lines A1, A2, A3, and A4 may form a power supply line that connects the first electrode contact layers M1 of the first to fourth groups of light-emitting elements E1, E2, E3, and E4. More specifically, the first group of address lines A1 may connect the first electrode contact layers M1 of the first group of light-emitting elements E1. The second group of address lines A2 may connect the first electrode contact layers M1 of the second group of light-emitting elements E2. The third group of address lines A3 may connect the first electrode contact layers M1 of the third group of light-emitting elements E3. The fourth group of address lines A4 may connect the first electrode contact layers M1 of the fourth group of light-emitting elements E4.

As described above, the first to fourth groups of address lines A1, A2, A3, and A4 may be connected to the first electrode contact layers M1 of the first to fourth groups of light-emitting elements E1, E2, E3, and E4. The second electrode contact layers M2 of the first to fourth groups of light-emitting elements E1, E2, E3, and E4 may be connected to a common ground line. In an embodiment of the present disclosure, the first electrode contact layers M1 of the first to fourth groups of light-emitting elements E1, E2, E3, and E4 may be connected to the first to fourth groups of address lines A1, A2, A3, and A4 that are electrically spaced apart from each other. Unlike the first electrode contact layers M1 of the first to fourth groups of light-emitting elements E1, E2, E3, and E4, the second electrode contact layers M2 of the first to fourth groups of light-emitting elements E1, E2, E3, and E4 may be connected to the common ground line and thus may be electrically connected.

Referring to FIG. 25, in an embodiment of the present disclosure, the first to fourth groups of light-emitting elements E1, E2, E3, and E4 and/or the first to fourth groups of light-emitting element assemblies ES1, ES2, ES3, and ES4 may be controlled to be selectively turned on/off by using the first to fourth groups of address lines A1, A2, A3, and A4 that are electrically spaced apart from each other so that the driving power supply V is applied to the first to fourth groups of address lines A1, A2, A3, and A4 that are individually formed or independently applied to the first to fourth groups of address lines A1, A2, A3, and A4. For example, a switch SW may be interposed between the driving power supply V included in the light-emitting unit EU and the first to fourth groups of address lines A1, A2, A3, and A4. In an embodiment of the present disclosure, the switch SW may be implemented with a 5-contact point switch SW and/or a multiplexer that is interposed between the first to four contact points CP1, CP2, CP3, and CP4 that are connected to the first to fourth groups of address lines A1, A2, A3, and A4, respectively, and the terminal of the driving power supply V and that connects any one of the first to four contact points CP1, CP2, CP3, and CP4 and the terminal of the driving power supply V in response to a control signal. In contrast, the switch SW may be implemented in the form of a 4-stage selector switch in which the first to four contact points CP1, CP2, CP3, and CP4 are arranged in a circumferential direction thereof and which can be circularly rotated along the first to four contact points CP1, CP2, CP3, and CP4 so that a user's setting from the outside is possible. The switch SW may perform a switching operation of alternately connecting the first to four contact points CP1, CP2, CP3, and CP4 under the control of an operation processing unit (not illustrated) that applies the control signal based on a user's setting or the state in which a transport robot on which the TOF sensor TOF is mounted travels. For example, the switch SW may connect the first contact point CP1 (i.e., the first group of address lines A1 and/or the first group of light-emitting element assemblies ES1) so that a short-distance visual field is provided when the transport robot travels at a relatively low speed, while operating in conjunction with the travel speed of the transport robot, and may gradually change the connection state from the second contact point CP2 to the fourth contact point CP4 (i.e., the fourth group of address lines A4 and/or the fourth group of light-emitting element assemblies ES4) as the travel speed is increased. For example, when the transport robot on which the TOF sensor TOF is mounted travels at a high speed, the switch SW may connect the fourth contact point CP4 (i.e., the fourth group of address lines A4 and/or the fourth group of light-emitting element assemblies ES4) so that a long-distance visual field is provided.

For example, the transport robot may change the switch SW so that the switch is connected to the first contact point CP1 in order to densely detect a short-distance visual field while traveling at a low speed in an area in which the surrounding object B is relatively concentrated (i.e., an area in which many obstacles are present) (i.e., provides a dense visual field without a gap in overlap spot sizes by using the first group of light-emitting element assemblies ES1 connected to the first contact point CP1 and/or the first group of address lines A1). The transport robot may change the switch SW so that the switch is connected to the fourth contact point CP4 in order to detect a long-distance visual field while traveling at a high speed in an area in which the surrounding object B is relatively dispersed (i.e., an area in which small obstacles are present).

In various embodiments of the present disclosure, the first to fourth groups of address lines A1, A2, A3, and A4 may extend in various forms. For example, in the embodiment illustrated in FIG. 19, the base substrate S may include first and second side parts S1 and S2 that cross each other. In this case, the first to fourth groups of light-emitting elements E1, E2, E3, and E4 may be arranged in the direction of the first side part S1 of the base substrate S and alternately disposed in the direction of the second side part S2. The first to fourth groups of address lines A1, A2, A3, and A4 may extend in a direction parallel to the first side part S1 of the base substrate S, and may incorporate multiple light-emitting elements E, which are arranged in parallel in the direction of the first side part S1 of the base substrate S, into a group of light-emitting elements E that belongs to the same group as the multiple light-emitting elements E. For example, the first to fourth groups of light-emitting element assemblies ES1, ES2, ES3, and ES4 may be arranged in the direction of the first side part S1 and circularly alternately disposed in the direction of the second side part S2. The first group of address lines A1 may extend in the direction of the first side part S1, and may electrically connect the first group of light-emitting element assemblies ES1 (i.e., the first electrode contact layers M1 of the first group of light-emitting elements E1) that is arranged in the direction of the first side part S1. Likewise, each of the second to fourth groups of address lines A2, A3, and A4 may extend in the direction of the first side part S1, and may electrically connect the second to fourth groups of light-emitting element assemblies ES2, ES3, and ES4 (i.e., the first electrode contact layers M1 of the second to fourth light-emitting elements E2, E3, and E4) that are arranged in the direction of the first side part S1.

In an embodiment of the present disclosure, the first to fourth groups of address lines A1, A2, A3, and A4 may extend in parallel in the direction of the first side part S1. The first to fourth groups of multiple address lines A1, A2, A3, and A4 may be circularly alternately disposed in the direction of the second side part S2. First to fourth groups of wiring lines C1, C2, C3, and C4 that extend to cross the ends of the first to fourth groups of multiple address lines A1, A2, A3, and A4, respectively, while extending in the direction of the second side part S2 may be disposed to connect the first to fourth groups of multiple address lines A1, A2, A3, and A4 that extend in parallel in the direction of the first side part S1.

In another embodiment of the present disclosure, as illustrated in FIG. 20, the base substrate S may include first and second side parts S1 and S2 that cross each other. The first to fourth groups of light-emitting elements E1, E2, E3, and E4 may be arranged in a diagonal direction that tracks both the directions of the first and second side parts S1 and S2. The first to fourth groups of address lines A1, A2, A3, and A4 may extend in the diagonal direction that tracks both the directions of the first and second side parts S1 and S2 of the base substrate S, and may incorporate multiple light-emitting elements E, which are arranged in parallel in the diagonal direction, into a group of light-emitting element E that belongs to the same group as the multiple light-emitting elements E. For example, the first to fourth groups of light-emitting element assemblies ES1, ES2, ES3, and ES4 may be arranged in the diagonal direction that tracks both the directions of the first and second side parts S1 and S2, and may be circularly alternately disposed in a cross diagonal direction that intersects the diagonal direction. The first group of address lines A1 may extend in the diagonal direction, and may electrically connect the first group of light-emitting element assemblies ES1 (i.e., the first electrode contact layers M1 of the first group of light-emitting elements E1) that is arranged in the diagonal direction. Likewise, each of the second to fourth groups of address lines A2, A3, and A4 may extend in the diagonal direction, and may electrically connect each of the second to fourth groups of light-emitting element assemblies ES2, ES3, and ES4 (i.e., the first electrode contact layers M1 of the second to fourth light-emitting elements E2, and E3, and E4) that are arranged in the diagonal direction.

In an embodiment of the present disclosure, the first to fourth groups of address lines A1, A2, A3, and A4 may include first to fourth groups of multiple address lines A1, A2, A3, and A4 that extend in parallel in the diagonal direction, respectively. The first to fourth groups of multiple address lines A1, A2, A3, and A4 may be circularly alternately disposed to cross each other in the cross diagonal direction that intersects the diagonal direction. In an embodiment of the present disclosure, first to fourth groups of wiring lines C1, C2, C3, and C4 that extend to cross the ends of the first to fourth groups of multiple address lines A1, A2, A3, and A4, respectively, while each extending in a bent form along the first and second side parts S1 and S2 may be disposed. The first to fourth groups of wiring lines C1, C2, C3, and C4 may connect the first to fourth groups of multiple address lines A1, A2, A3, and A4 that extend in parallel in the diagonal direction.

In various embodiments of the present disclosure, the first to fourth groups of address lines A1, A2, A3, and A4 and the first to fourth groups of wiring lines C1, C2, C3, and C4 may be disposed on the top surface of the light-emitting element E in which the first electrode contact layer M1 is disposed or the top surface of the light-emitting element array EA in the multiple light-emitting elements E are arranged.

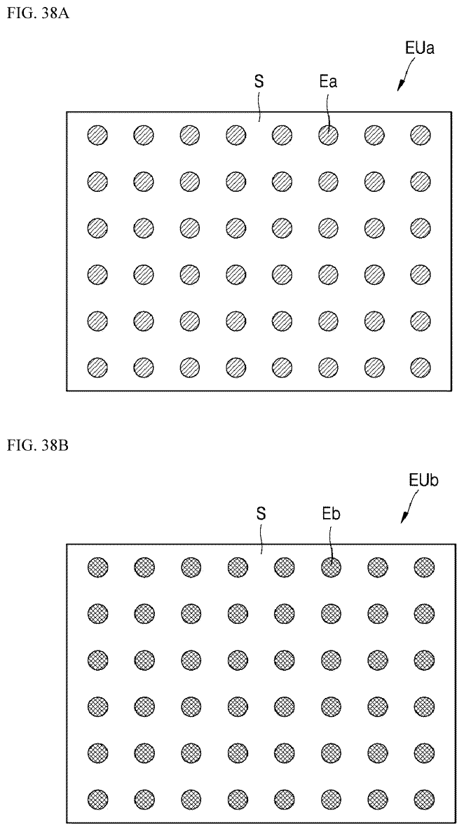

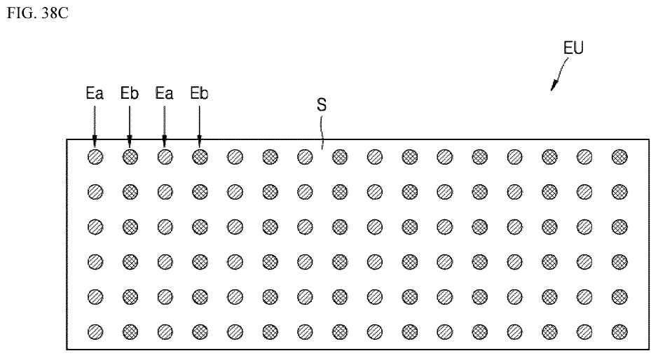

FIGS. 38A to 38C illustrate diagrams for describing a technical effect that reduces the degradation of the light-emitting element E in the light-emitting element array EA or the light-emitting unit EU including the light-emitting element array EA according to an embodiment of the present disclosure.

Referring to FIGS. 38A to 38C, an embodiment of the present disclosure discloses the TOF sensor TOF that includes the light-emitting element array EA formed on the one base substrate S and that may provide lights having optical characteristics changed adaptively and flexibly, while applying the light-emitting element array EA, by using the first to fourth groups of address lines A1, A2, A3, and A4 that independently drive the first to fourth groups of light-emitting element assemblies ES1, ES2, ES3, and ES4, respectively, the driving power supply V that selectively drives the first to fourth groups of address lines A1, A2, A3, and A4, and the switch SW connected to the driving power supply V. In particular, in an embodiment of the present disclosure, all of the light-emitting elements E arranged on the one base substrate S are not simultaneously turned on according to time, but may perform switching operations between the first to fourth groups of address lines A1, A2, A3, and A4 and the driving power supply V. Accordingly, a group of light-emitting elements E, among the first to fourth groups of light-emitting elements E1, E2, E3, and E4, is optionally turned on. Accordingly, the TOF sensor TOF is advantageous for heat dissipation, and can have a simplified heat dissipation structure compared to the same number of light-emitting elements E.

Referring to FIGS. 38A and 38B, a comparison example compared to the present disclosure may include a base substrate S including multiple light-emitting elements Ea and Eb belonging to different groups and light-emitting units EUa and EUb including different base substrate S and having a form in which the light-emitting units EUa and EUb are separated from each other so that different spot sizes and different visual field distances are provided. In such an embodiment, the light-emitting elements Ea and Eb arranged to be adjacent to each other may cause a heat dissipation problem while being simultaneously turned on. For example, a separate heat dissipation design may be required for each of the light-emitting units EUa and EUb. Referring to FIG. 38C, in an embodiment of the present disclosure, light-emitting elements Ea and Eb belonging to different groups (or different groups of light-emitting element assemblies) that provide lights having different forms are formed on one base substrate S, and any one group of light-emitting elements Ea and Eb (or any one group of light-emitting elements assembly) are not simultaneously turned on and are selectively turned on. Accordingly, in an embodiment of the present disclosure, the light-emitting unit EU that selectively provides lights having different forms can be provided in a more compact form, and convenience in the process can be promoted. Furthermore, in an embodiment of the present disclosure, heat can be rapidly discharged through the base substrate S having a wide area in accordance with a switching operation of alternately turning on the light-emitting elements at different times. A separate heat dissipation design may not be required.

In an embodiment of the present disclosure, a recognition error of the surrounding object B according to the degradation of the light-emitting element E (e.g., a recognition error that occurs because the surrounding object B is not recognized due to the degradation of the light-emitting element E) in the light-emitting element array EA including the multiple light-emitting elements E, the light-emitting unit EU including the light-emitting element array EA, and the TOF sensor TOF including the light-emitting unit EU can be prevented because the ion implantation layer P is formed in each light-emitting element E in order to block the movement of a defect from a defect source to the central region of the active layer AR. Although the multiple light-emitting elements E are arranged on the one base substrate S, it is preferred that an appropriate amount of light that is output from each light-emitting element E turned on according to time is maintained by considering the number of light-emitting elements E (i.e., only any one group of light-emitting elements E, among the first to fourth groups of light-emitting elements E1, E2, E3, and E4, is selectively turned on according to time). In an embodiment of the present disclosure, it may be preferred that the movement of a defect from a defect source to the central region of the active layer AR is blocked in order to prevent the degradation of each light-emitting element E.

An embodiment of the present disclosure discloses the light-emitting element unit EU, including the multiple light-emitting elements E including different first to fourth groups of light-emitting elements E1, E2, E3, and E4, the multiple optical lenses F including the first to fourth groups of optical lenses F1, F2, F3, and F4 disposed on the first to fourth groups of light-emitting elements E1, E2, E3, and E4, respectively, and the multiple address lines A including the first to fourth groups of address lines A1, A2, A3, and A4 that are electrically connected to the first to fourth groups of light-emitting elements E1, E2, E3, and E4, respectively, and that are electrically spaced apart from each other.

In various embodiments of the present disclosure, the light-emitting element unit EU may include the light-emitting element E that is connected and electrically wired to a different address line A and the optical lens F disposed on the light-emitting element E. One group of light-emitting elements E and the other group of light-emitting elements E may be connected by a different group of the address lines A and the other group of address lines A, and may be driven at different times. In various embodiments of the present disclosure, the light-emitting element unit EU includes a different group of light-emitting elements E and the other group of light-emitting elements E that are electrically wired through a different group of address lines A and the other group of address lines A and that may be turned on/off by the switch at different times. In various embodiments of the present disclosure, in order to provide lights having forms, which are output from a different group of light-emitting elements E and the other group of light-emitting elements E, with different spot sizes and at different visual field distance, the light-emitting element unit EU may include one group of optical lenses F and the other group of optical lenses F disposed on a different group of light-emitting elements E and the other group of light-emitting elements E.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A light-emitting unit comprising:
a base substrate;
light-emitting elements that are arranged on the base substrate as a plurality of groups and that are sequentially arranged on an outermost side of the base substrate and an inside thereof in a preset form; and
address lines that are electrically connected to the groups of light-emitting elements, respectively, and that are electrically spaced apart from each other.

2. The light-emitting unit of claim 1, further comprising optical lenses arranged as a plurality of groups and disposed on each group of light-emitting elements.

3. The light-emitting unit of claim 1, wherein the preset form is a rectangular form.

4. The light-emitting unit of claim 1, wherein the preset form is a rectangular form in which one surface of the light-emitting element is opened.

5. The light-emitting unit of claim 1, wherein a group of light-emitting elements that needs to radiate a light with relatively higher output is arranged on the outermost side.

6. The light-emitting unit of claim 5, wherein the group of light-emitting elements is arranged inward therefrom in order of relatively weaker output.

7. The light-emitting unit of claim 1, further comprising a switch for changing an alternative connection with a driving power supply between each group of address lines and the driving power supply.

8. A time of flight (TOF) sensor comprising:
a light-emitting element array comprising a light-emitting unit;
a light-receiving unit configured to receive reflected light reflected by an object; and
an operation processing unit configured to calculate a light flight time corresponding to a time difference between a light transmission time from the light-emitting unit and a light reception time when the light-receiving unit detects the reflected light, based on the light transmission time and the light reception time, and to calculate a distance up to the object based on the light flight time,
wherein the light-emitting unit comprises:
a base substrate;
light-emitting elements that are arranged on the base substrate as a plurality of groups and that are sequentially arranged on an outermost side of the base substrate and an inside thereof in a preset form; and
address lines that are electrically connected to the groups of light-emitting elements, respectively, and that are electrically spaced apart from each other.

9. The TOF sensor of claim 8, wherein the preset form is a rectangular form or a rectangular form in which one surface of the light-emitting element is opened.

10. The TOF sensor of claim 8, wherein a group of light-emitting elements that needs to radiate a light with relatively higher output is arranged on the outermost side.
